(19) United States
(12) Patent Application Publication
(10) Pub. No.: US 2026/0260128 A1
(43) Pub. Date: Sep. 3, 2026

(54) PREDICTION SYSTEM AND MASS PRODUCTION METHOD

(71) Applicants: Tokyo Electron Limited, Tokyo (JP); NATIONAL UNIVERSITY CORPORATION HOKKAIDO UNIVERSITY, Hokkaido (JP)

(72) Inventors: Yukiya Saito, Hokkaido (JP); Takuro Tsutsui, Hokkaido (JP); Yuanchieh Ling, Hokkaido (JP); Tetsuya Asai, Hokkaido (JP); Kohei Nishida, Hokkaido (JP); Shohei Tatsumi, Hokkaido (JP)

(21) Appl. No.: 19/655,200

(22) Filed: Apr. 22, 2026

Related U.S. Application Data
(63) Continuation of application No. PCT/JP2024/038190, filed on Oct. 25, 2024.

(30) Foreign Application Priority Data
Nov. 2, 2023 (JP) 2023-188667

(51) Int. Cl. G06N 3/096

(52) U.S. Cl. CPC G06N 3/096

(57) ABSTRACT

A prediction system includes a calibration-verified AI device in which physical reservoirs configured to process a time-series signal are connected to each other; and a trained prediction device configured to read outputs from the physical reservoirs included in the calibration-verified AI device with readout weights being applied thereto and output a predicted value. The calibration-verified AI device includes the physical reservoirs verified to be calibrated so that physical properties of the physical reservoirs become equal to each other by adding an M-sequence noise to the time-series signal. The trained prediction device includes the readout weights copied from another trained prediction device in which readout weights have been updated by performing training, the another trained prediction device being configured to read outputs from other physical reservoirs having physical properties equal to the physical properties of the physical reservoirs with the readout weights being applied thereto and output a predicted value.

### CROSS-REFERENCE TO RELATED APPLICATIONS

This application is a continuation application of International Application No. PCT/JP2024/038190 filed on October 25, 2024, and designating the U.S., which is based upon and claims priority to Japanese Patent Application No. 2023-188667 filed on November 2, 2023, the entire contents of which are incorporated herein by reference.

### BACKGROUND

### 1. Technical Field

The present disclosure relates to a prediction system and a mass production method.

### 2. Description of the Related Art

In general, when AI devices such as nanomolecular reservoirs are mass-produced, individual differences occur among the mass-produced AI devices. Therefore, when a plurality of prediction systems each including a mass-produced AI device are generated, the respective prediction systems cannot use the training results of other prediction systems, and must perform training from scratch at startup.

### Related Art Documents

### Non-Patent Documents

Non-Patent Document 1: Tanaka H., Akai-Kasaya M., Termeh A.Y., Hong L., Fu L., Tamukoh H., Tanaka D., Asai T., and Ogawa T., A molecular neuromorphic network device consisting of single-walled carbon nanotubes complexed with polyoxometalate Nature Communications, vol. 9, p. 2693 (2018)

Non-Patent Document 2: Atsushi Uchida, Ryan McAllister, and Rajarshi Roy, Consistency of Nonlinear System Response to Complex Drive Signals, PHYSICAL REVIEW LETTERS, vol. 93, 244102 (2004)

### SUMMARY

According to one embodiment of the present disclosure, a prediction system includes a calibration-verified AI device in which a plurality of physical reservoirs configured to process a time-series signal are connected to each other; and a trained prediction device configured to read outputs from the plurality of physical reservoirs included in the calibration-verified AI device with readout weights being applied thereto and output a predicted value. The calibration-verified AI device includes the plurality of physical reservoirs verified to be calibrated so that physical properties of the plurality of physical reservoirs become equal to each other by adding an M-sequence noise to the time-series signal. The trained prediction device includes the readout weights that are copied from another trained prediction device in which readout weights have been updated by performing training, the another trained prediction device being configured to read outputs from a plurality of other physical reservoirs having physical properties equal to the physical properties of the plurality of physical reservoirs with the readout weights being applied thereto and output a predicted value.

### BRIEF DESCRIPTION OF THE DRAWINGS

FIGS. 1A and 1B are diagrams each illustrating an application example of a trained first prediction system.

FIG. 2 is a diagram illustrating an example of a system configuration of the trained first prediction system;

FIG. 3 is a diagram illustrating an example of a detailed configuration of a calibration-verified AI device and a trained prediction device in the trained first prediction system;

FIG. 4 is a first diagram illustrating a flow from generation to startup of a first prediction system;

FIG. 5 is a second diagram illustrating a flow from generation to startup of the first prediction system;

FIG. 6 is a diagram illustrating a specific example of a calibration verification process for an AI device;

FIG. 7 is a diagram illustrating an example of a processing section of the calibration-verified AI device.

FIG. 8 is a diagram illustrating a specific example of a training process of a prediction device in the first prediction system;

FIG. 9 is a diagram illustrating a specific example of a readout weight sharing process of the prediction device in the first prediction system;

FIG. 10A is a diagram illustrating a specific example of a verification process of the trained first prediction system;

FIG. 10B is a diagram illustrating a specific example of a retraining process of the trained prediction device in the trained first prediction system;

FIG. 11 is a diagram illustrating an example of a system configuration of a trained second prediction system;

FIG. 12 is a diagram illustrating an example of a detailed configuration of an AI device, a trained correction device, and a trained prediction device in the trained second prediction system;

FIG. 13 is a first diagram illustrating a flow from generation to startup of the second prediction system;

FIG. 14 is a second diagram illustrating a flow from generation to startup of the second prediction system;

FIG. 15 is a diagram illustrating a specific example of a training process of a correction device;

FIG. 16 is a diagram illustrating a specific example of a verification process of the trained correction device;

FIG. 17 is a diagram illustrating a specific example of a training process of a prediction device in the second prediction system;

FIG. 18 is a diagram illustrating a specific example of a readout weight sharing process of the prediction device in the second prediction system;

FIG. 19A is a diagram illustrating a specific example of a verification process of the trained second prediction system; and

FIG. 19B is a diagram illustrating a specific example of a retraining process of the trained prediction device in the trained second prediction system.

### DETAILED DESCRIPTION

Hereinafter, embodiments will be described with reference to the accompanying drawings. Here, in the present specification and the drawings, components having substantially the same functional configuration are denoted by the same reference numerals and duplicated descriptions thereof will be omitted.

### First Embodiment

### Application Example of Trained First Prediction System

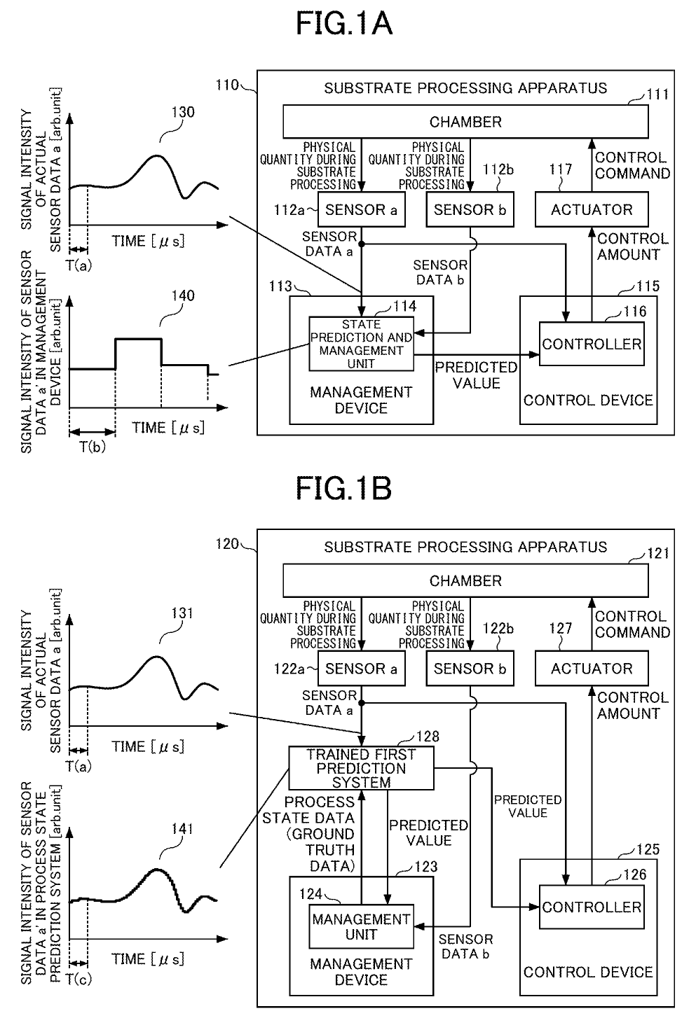

First, an application example of a trained first prediction system according to a first embodiment, generated by performing training on a prediction system (hereinafter referred to as a first prediction system), will be described. FIG. 1 is a diagram illustrating an application example of the trained first prediction system.

Here, in the example of FIGS. 1A and 1B, a case where the trained first prediction system is applied to a substrate processing apparatus will be described, but the application target of the trained first prediction system is not limited to the substrate processing apparatus, and may be an apparatus that performs another manufacturing process.

Additionally, in FIGS. 1A and 1B, a substrate processing apparatus to which the trained first prediction system is not applied (FIG. 1A) is illustrated as a comparative example in addition to a substrate processing apparatus to which the trained first prediction system is applied (FIG. 1B), and differences between the two substrate processing apparatuses will be compared and described as appropriate.

As illustrated in FIGS. 1A and 1B, substrate processing apparatuses 110 and 120 include chambers 111 and 121 configured to process substrates, sensors a112a and 122a, and sensors b112b and 122b. Additionally, the substrate processing apparatuses 110 and 120 include management devices 113 and 123, control devices 115 and 125, and actuators 117 and 127. The management devices 113 and 123 and the control devices 115 and 125 are implemented by a central processing unit (CPU), a field programmable gate array (FPGA), or other circuitry.

As illustrated in FIG. 1A, which is a comparative example, in the substrate processing apparatus 110, the sensors a112a and b112b measure physical quantities during processing of the substrate in the chamber 111, and output the measured physical quantities as time-series sensor data a and sensor data b. In the case of a prediction process, the time-series sensor data a output from the sensor a112a is processed in a state prediction and management unit 114 of the management device 113 to predict a process state, and the predicted process state is output to the control device 115 as a predicted value. Here, the time-series sensor data b output from the sensor b112b is input to the state prediction and management unit 114 of the management device 113, and is used in a training process.

Additionally, the time-series sensor data a output from the sensor a112a is processed in a controller 116 of the control device 115 to calculate a control amount. At this time, the controller 116 may correct the control amount based on the predicted value. The control amount calculated by the controller 116 is output to the actuator 117, and the actuator 117 notifies the chamber 111 of a control command based on the control amount.

In FIG. 1A, a graph 130 is an example of the time-series sensor data a output from the sensor a112a, in which the horizontal axis represents the time and the vertical axis represents the signal intensity. Additionally, in FIG. 1A, a graph 140 is time-series sensor data a’ that is used when processed in the state prediction and management unit 114 of the management device 113, in which the horizontal axis represents the time and the vertical axis represents the signal intensity.

Generally, a processing period T(b) used when the management device 113 predicts the process state is longer than a measurement period T(a) used when the sensor a112a measures the time-series sensor data a. Therefore, the state prediction and management unit 114 cannot capture a short behavior appearing in the time-series sensor data a as illustrated in the graph 130 (see graph 140), and consequently, it is difficult to obtain sufficient prediction accuracy when predicting the process state.

As illustrated in FIG. 1B, in the substrate processing apparatus 120, the sensor a 122a and the sensor b 122b measure physical quantities during processing of the substrate in the chamber 121, and output the measured physical quantities as the time-series sensor data a and sensor data b. In the prediction process, the time-series sensor data a output from the sensor a 122a is processed in a trained first prediction system 128 to predict the process state. The value predicted by the trained first prediction system 128 is output to a management unit 124 of the management device 123 and a controller 126 of the control device 125. Here, the time-series sensor data b output from the sensor b 122b is input to the management unit 124 of the management device 123, and is used as process state data (ground truth data) when the trained first prediction system is retrained (which will be described in detail later).

Additionally, the time-series sensor data a output from the sensor a 122a is processed in the controller 126 of the control device 125 to calculate a control amount. At this time, the controller 126 may correct the control amount based on the predicted value. The control amount calculated by the controller 126 is output to the actuator 127, and the actuator 127 notifies the chamber 121 of a control command based on the control amount.

Here, in FIG. 1B, a graph 131 is an example of the time-series sensor data a output from the sensor a 122a, in which the horizontal axis represents the time and the vertical axis represents the signal intensity. In FIG. 1B, a graph 141 is time-series sensor data a’ that is used when processed in the trained first prediction system 128, in which the horizontal axis represents the time and the vertical axis represents the signal intensity.

In the case of the trained first prediction system 128, the time-series sensor data a’ is processed by reservoir computing to predict the process state. Therefore, a processing period T(c) used when predicting the process state is significantly shorter than the processing period T(b) used when the management device 113 illustrated in FIG. 1A predicts the process state. As a result, according to the trained first prediction system 128, a short behavior appearing in the time-series sensor data a illustrated in the graph 131 can be captured, thereby improving the prediction accuracy.

### System Configuration of Trained First Prediction System

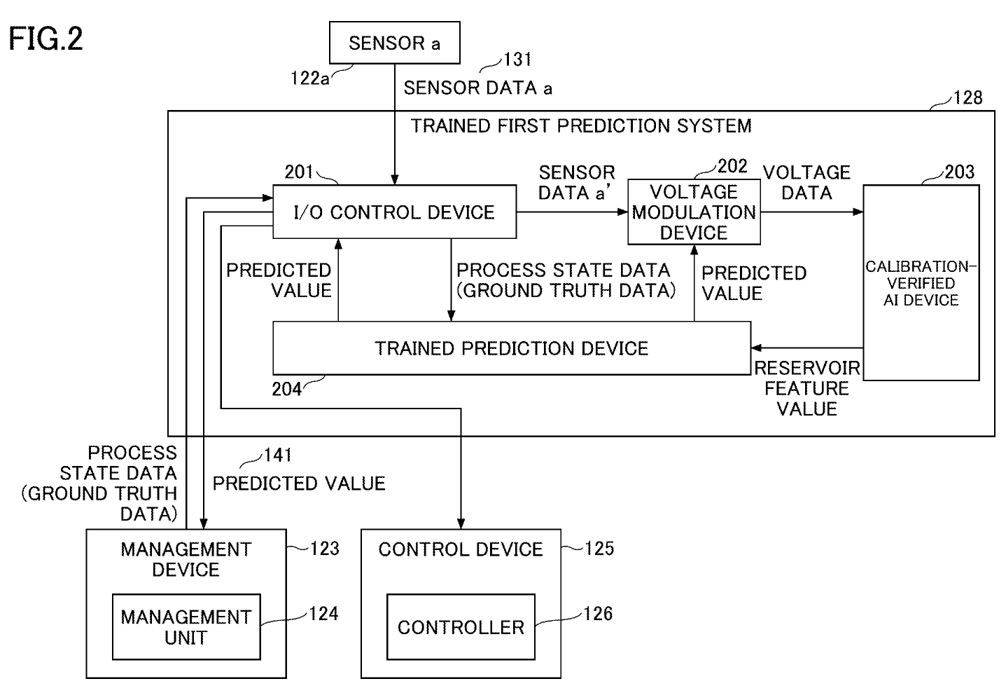

Next, a system configuration of the trained first prediction system 128 will be described. FIG. 2 is a diagram illustrating an example of the system configuration of the trained first prediction system.

As illustrated in FIG. 2, the trained first prediction system 128 includes an I/O control device 201, a voltage modulation device 202, a calibration-verified AI device 203, and a trained prediction device 204. The I/O control device 201, the voltage modulation device 202, and the trained prediction device 204 are implemented by a central processing unit (CPU), a field programmable gate array (FPGA), or other circuitry. The calibration-verified AI device 203 is implemented by a field programmable gate array (FPGA), or other circuitry.

The I/O control device 201 controls the input and output of digital signals. Specifically, when the time-series sensor data a output from the sensor a 122a is input, the I/O control device 201 notifies the voltage modulation device 202 of the sensor data a’.

Here, the time-series sensor data a input to the I/O control device 201 may be one type of time-series sensor data or a sensor data set including a plurality of types of time-series sensor data. Here, for simplification of the description, the following description assumes that one type of time-series sensor data is input.

Additionally, the I/O control device 201 acquires a predicted value output from the trained prediction device 204 (a value resulting from a predicted process state) and transmits it to the management device 123 or the control device 125. Additionally, the I/O control device 201 notifies the trained prediction device 204 when the management device 123 inputs process state data (ground truth data) to be used to perform retraining (which will be described later in detail) in the trained first prediction system 128.

The voltage modulation device 202 is an example of a modulation device, and converts the time-series sensor data a’ received from the I/O control device 201 into voltage data to be input to the calibration-verified AI device 203. Specifically, the voltage modulation device 202 acquires and modulates the sensor data a’ at a sampling frequency of 1 MHz or higher, thereby converting the sensor data a’ into the voltage data.

Here, the voltage modulation device 202 may convert the time-series sensor data a’ received from the I/O control device 201 into voltage data in accordance with the predicted value output by the trained prediction device 204, for example.

The calibration-verified AI device 203 is a device configured to output reservoir feature values, and is an AI device verified to be calibrated so as to eliminate individual differences among mass-produced AI devices. The AI device referred to herein is, for example, a device configured to include a physical reservoir, convert a current signal output from the physical reservoir, to which a voltage signal based on voltage data is input, into voltage data, and output reservoir feature values. Here, the reservoir feature value is a numerical value quantitatively representing a characteristic of the time-series sensor data a’ that is output by the physical reservoir based on respective values of the time-series sensor data a’ from the past to the present when the respective values are input to the physical reservoir.

The trained prediction device 204 is a prediction device configured to read the reservoir feature values output from the calibration-verified AI device 203 with readout weights being applied thereto and output a predicted value, and is a prediction device in which the readout weights are optimized by the training process. The trained prediction device 204 outputs the predicted value to the I/O control device 201 and the voltage modulation device 202.

Here, when performing retraining (which will be described later in detail), the trained prediction device 204 re-updates the readout weights so that the predicted value is correlated with the process state data (ground truth data) input by the I/O control device 201.

### Details of Process State Prediction System

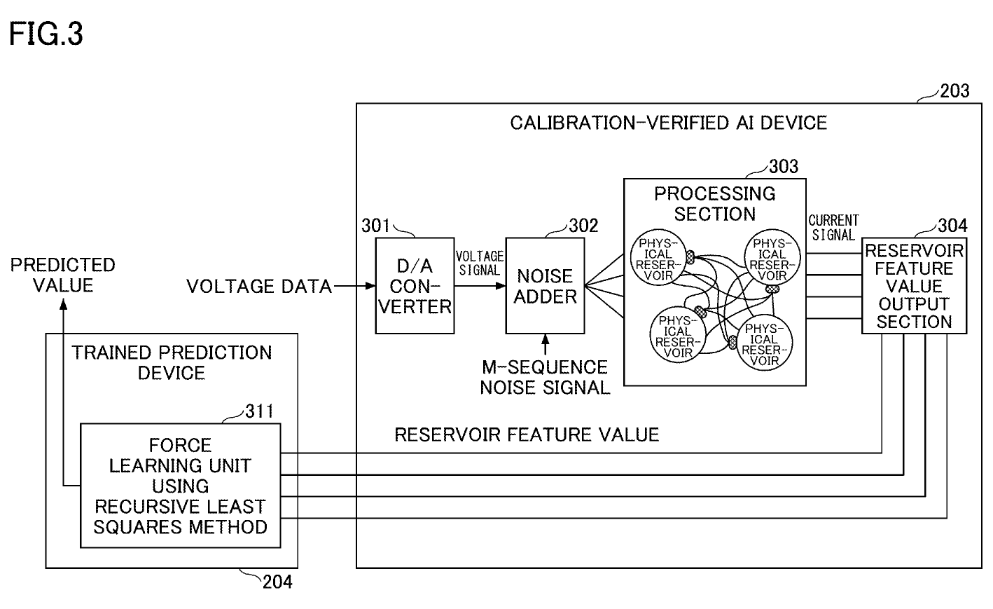

Next, a detailed configuration of each device (here, the calibration-verified AI device 203 and the trained prediction device 204) in the trained first prediction system 128 illustrated in FIG. 2 will be described. FIG. 3 is a diagram illustrating an example of the detailed configuration of the calibration-verified AI device and the trained prediction device in the trained first prediction system.

### (1) Detailed Configuration of Calibration-verified AI Device

First, the detailed configuration of the calibration-verified AI device 203 will be described. As illustrated in FIG. 3, the calibration-verified AI device 203 includes a D/A converter 301, a noise adder 302, a processing section 303, and a reservoir feature value output section 304.

The D/A converter 301 performs D/A conversion on the time-series voltage data input by the voltage modulation device 202 to generate a time-series analog voltage signal, and inputs it to the noise adder 302.

The noise adder 302 adds an M-sequence noise signal to the time-series analog voltage signal.

The processing section 303 includes a plurality of physical reservoirs configured to process the time-series analog voltage signal to which the M-sequence noise signal is added, and the plurality of physical reservoirs are connected to each other.

In general, the physical reservoir refers to a reservoir that physically exists (or can exist) in the real world, not a reservoir that exists on a computer. Additionally, the reservoir refers to a network of a complex system in which a plurality of reservoir nodes are mutually connected, and retains reservoir feature values for an input of a voltage signal from the past to the present. Further, the reservoir node refers to a basic component in the reservoir, and is configured to receive an input of one or more voltage signals, linearly converts or non-linearly converts the value thereof (or the values thereof), and outputs a current signal. The reservoir node is not a static element but a dynamic element (the state of the node itself at the next time is determined from the current state of the node itself and the state of another connected node). The output of the current signal by the reservoir node follows the input of the current voltage signal while forgetting the input of the past voltage signal.

Here, in the first embodiment, the plurality of physical reservoirs included in the processing section 303 serves as the plurality of reservoir nodes included in the reservoir. That is, in the first embodiment, the processing section 303 serves as the reservoir, and the plurality of physical reservoirs serve as the plurality of reservoir nodes. Additionally, in the first embodiment, the physical reservoirs include at least one of a nanomolecular reservoir, a spin reservoir, an optical reservoir, a CMOS reservoir, or a memristor reservoir. For example, it is assumed that a plurality of nanomolecular reservoirs are used as the plurality of physical reservoirs. The nanomolecular reservoir is a physical reservoir formed of POM molecules and carbon nanotubes. The POM molecules are polyacid molecules and have a property of accumulating charges and releasing the accumulated charges when the accumulated amount exceeds a certain threshold.

Additionally, in the calibration-verified AI device 203, it has been verified that the plurality of physical reservoirs in the processing section 303 are calibrated so that the physical properties thereof are equal to each other by adding the M-sequence noise signal. Additionally, it has been verified that the plurality of physical reservoirs in the processing section 303 are calibrated so that the physical properties thereof are equal to the physical properties of other mass-produced physical reservoirs by adding the M-sequence noise signal. Here, the other mass-produced physical reservoirs refer to physical reservoirs other than the physical reservoirs mounted on the processing section 303 of the calibration-verified AI device 203.

Additionally, in the calibration-verified AI device 203, the plurality of physical reservoirs in the processing section 303 are configured such that the outputs of the physical reservoirs of the connection source are averaged over a predetermined period of time, a weight for a physical reservoir at a connection destination is applied, and the result is then input to the physical reservoir of the connection destination.

The reservoir feature value output section 304 reads a current signal from each of the plurality of physical reservoirs, converts it into voltage data, and outputs it to the trained prediction device 204 as the reservoir feature value.

As described above, by adopting the configuration that uses the plurality of physical reservoirs, the calibration-verified AI device 203 can capture a short behavior appearing in the sensor data a and output the reservoir feature value.

### (2) Detailed Configuration of Trained Prediction Device

Next, a detailed configuration of the trained prediction device 204 will be described. As illustrated in FIG. 3, the trained prediction device 204 includes a FORCE learning unit 311 using the recursive least squares method. The prediction device 204 is implemented by a central processing unit (CPU), a field programmable gate array (FPGA), or other circuitry.

In the first embodiment, readout weights calculated by performing a FORCE learning process using the recursive least squares method are set in the FORCE learning unit 311 using the recursive least squares method. Alternatively, in the first embodiment, readout weights calculated by performing a FORCE learning process using the recursive least squares method by another FORCE learning unit using the recursive least squares method are copied and set in the FORCE learning unit 311 using the recursive least squares method. The FORCE learning unit 311 using the recursive least squares method is an example of a prediction unit, and reads reservoir feature values output from the reservoir feature value output section 304 with readout weights being applied thereto, and outputs a predicted value.

Here, the readout weights set in the FORCE learning unit 311 using the recursive least squares method may be re-updated by retraining.

### FLOW FROM GENERATION TO STARTUP OF FIRST PREDICTION SYSTEM

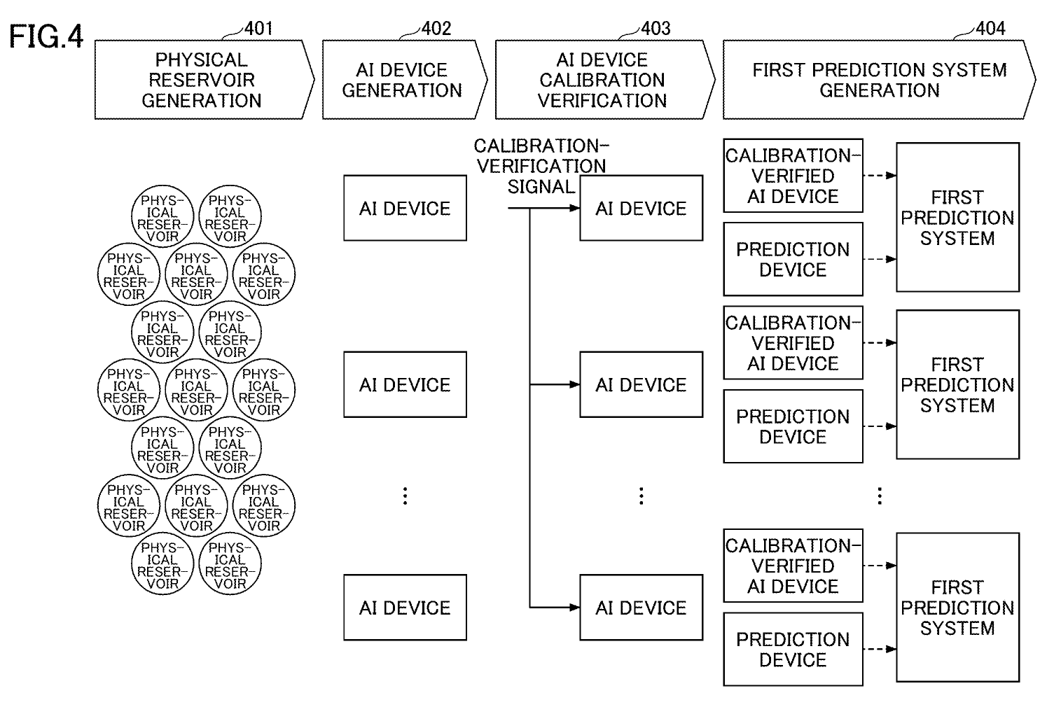

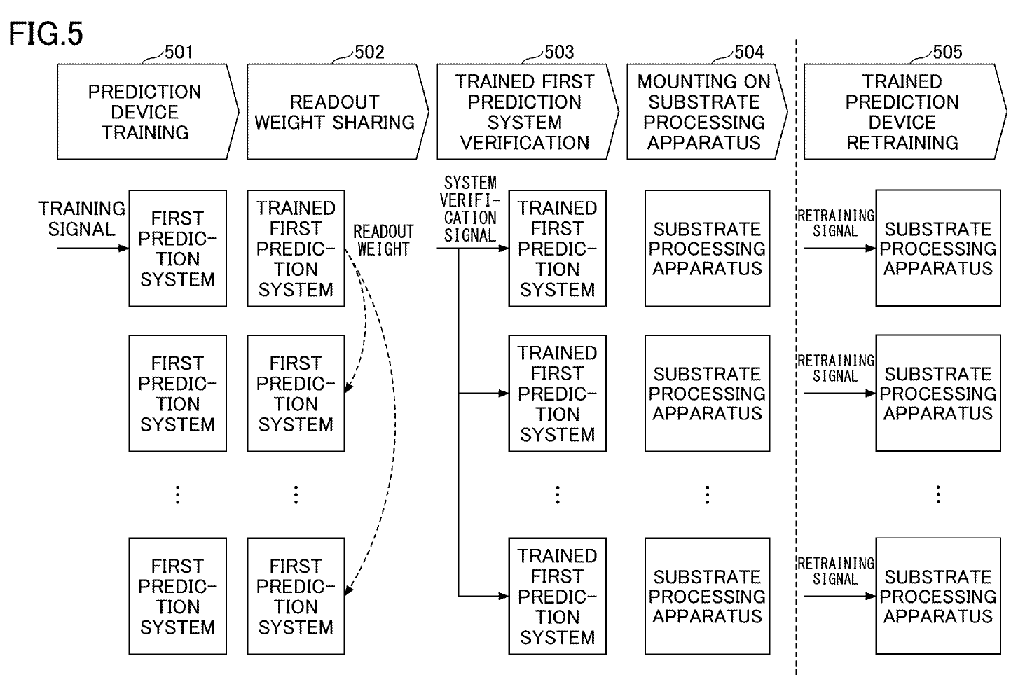

Next, a flow from generation to startup of the first prediction system will be described with reference to FIGS. 4 and 5. FIGS. 4 and 5 are first and second diagrams illustrating the flow from generation to startup of the first prediction system.

As described with reference to FIGS. 1 to 3, the trained first prediction system 128 is applied to the substrate processing apparatus 120 or the like, the substrate processing apparatus to which it is applied is generally mass-produced, and a startup process is performed at a delivery destination. Therefore, it is desirable that the trained first prediction system is also mass-produced by a method suitable for mass-production and startup.

When mass-producing the trained first prediction system, it is necessary to mass-produce physical reservoirs, and in general, when mass-producing physical reservoirs, individual differences occur among the mass-produced physical reservoirs.

Therefore, when first prediction systems are formed using the mass-produced physical reservoirs, individual differences also occur in the first prediction systems, and the substrate processing apparatus to which the first prediction system is applied cannot reuse the training result of another mass-produced first prediction system. As a result, the substrate processing apparatus to which the first prediction system is applied needs to perform training from scratch at startup. That is, the workload when starting up the substrate processing apparatus increases.

If individual differences in the first prediction systems can be eliminated by eliminating individual differences among mass-produced physical reservoirs, there is no need to perform training from scratch at startup. For example, if training is performed using one specific prediction system and readout weights are calculated, the trained first prediction system can be generated for another first prediction system only by copying the calculated readout weights.

As a result, when starting up the substrate processing apparatus, instead of performing training from scratch, it is sufficient to retrain the trained first prediction system in accordance with the machine-to-machine difference of the substrate processing apparatus and re-update the readout weights, thereby reducing the workload when starting up. The flow from generation to startup of the first prediction system including the mass-production method according to the first embodiment will be described below with reference to FIGS. 4 and 5.

As illustrated in FIG. 4, in the first embodiment, first, a physical reservoir generation process 401 is performed. The physical reservoir generation process 401 generates the plurality of physical reservoirs. Here, as described above, the physical reservoirs mass-produced in the physical reservoir generation process 401 have different physical properties and individual differences.

Subsequently, an AI device generation process 402 is performed. As described above, the AI device includes the D/A converter 301, the noise adder 302, the processing section 303, and the reservoir feature value output section 304, and the processing section 303 includes the plurality of physical reservoirs. The plurality of physical reservoirs included in the processing section 303 have individual differences, and thus the plurality of AI devices mass-produced in the AI device generation process 402 also have individual differences. However, it is assumed that the plurality of AI devices mass-produced in the AI device generation process 402 are generated such that the numbers of physical reservoirs included in the respective processing sections 303 are equal to each other and the connection relationships are identical to each other.

Then, an AI device calibration verification process 403 is performed. In the AI device calibration verification process 403, calibration verification signals (including the M-sequence noise signal) are input to respective processing sections of the plurality of AI devices. With this, in the AI device calibration verification process 403, it is verified that the calibration is performed so that the physical properties among the plurality of physical reservoirs included in the processing sections of the AI devices are equal to each other. Additionally, in the AI device calibration verification process 403, it is verified that the calibration is performed so that the physical properties of the plurality of physical reservoirs included in the processing section 303 of one AI device are equal to the physical properties of the plurality of physical reservoirs included in the processing section 303 of another AI device.

When it is verified that the physical properties of the plurality of physical reservoirs are equal to each other in the AI device calibration verification process 403, a first prediction system generation process 404 is performed. The first prediction system generated by performing the first prediction system generation process 404 includes the I/O control device 201, the voltage modulation device 202, the calibration-verified AI device 203, and the prediction device.

Here, the prediction device illustrated in the first prediction system generation process 404 is a device including a FORCE learning unit using the recursive least squares method before training about the readout weights is performed.

As described, in the first prediction system generation process 404, the first prediction systems verified to be calibrated so that there are no individual differences are mass-produced.

Subsequently, as illustrated in FIG. 5, a prediction device training process 501 is performed. In the prediction device training process 501, a training signal is input to one specific first prediction system among a plurality of mass-produced first prediction systems, and training is performed on the one specific first prediction system. With this, the readout weights of the one specific first prediction system are optimized, and the trained first prediction system is generated.

Subsequently, a readout weight sharing process 502 is performed. The readout weight sharing process 502 copies the readout weights of the trained first prediction system to a plurality of first prediction systems other than the one specific first prediction system. With this, the trained first prediction systems are mass-produced for the plurality of first prediction systems other than the one specific first prediction system.

Subsequently, a trained first prediction system verification process 503 is performed. The trained first prediction system verification process 503 verifies that the identical predicted values (or within a predetermined error range) are output by inputting an identical system verification signal to the mass-produced plurality of trained first prediction systems.

Subsequently, a mounting process 504 on the substrate processing apparatus is performed. The mounting process on the substrate processing apparatus 504 mounts, on the mass-produced substrate processing apparatuses, the plurality of trained first prediction systems that are determined to have output the identical predicted values (or within a predetermined error range) as a result of the verification by the trained first prediction system verification process 503. Here, the substrate processing apparatuses on which the trained first prediction systems are mounted are delivered to respective delivery destinations, and installation work is performed.

When the installation work is completed, a startup process is performed on the substrate processing apparatus. At this point, because the prediction system mounted on the substrate processing apparatus has already been trained, in the startup process, a trained prediction device retraining process 505 for performing retraining in accordance with the machine-to-machine differences between the substrate processing apparatuses is performed.

Specifically, the trained prediction device retraining process 505 performs retraining by inputting a retraining signal to the trained first prediction system mounted on the substrate processing apparatus, and re-updates the readout weights.

As described, according to the flow from generation to startup of the first prediction system including the mass-production method according to the first embodiment, the workload at startup can be reduced.

### Details of Each Process

Next, details of each of the processes from generation to startup of the first prediction system will be described. Here, details of the AI device calibration verification process 403, the first prediction system generation process 404, the prediction device training process 501, the readout weight sharing process 502, the trained first prediction system verification process 503, and the trained prediction device retraining process 505 will be described.

### 1 Details of AI Device Calibration Verification Process

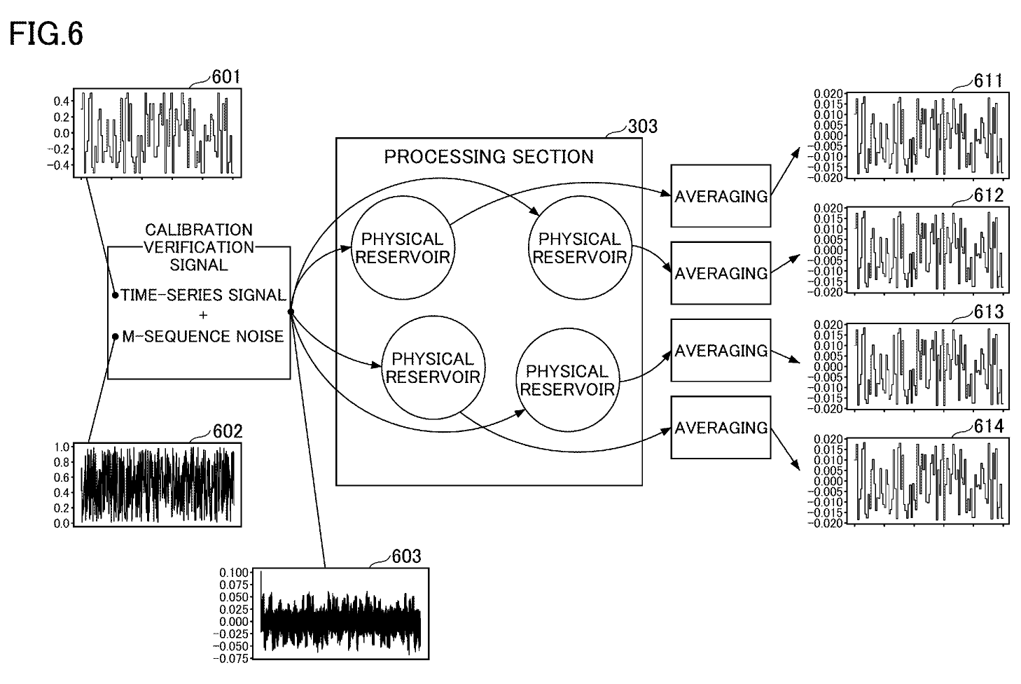

First, details of the AI device calibration verification process 403 will be described. FIG. 6 is a diagram illustrating a specific example of the AI device calibration verification process. As illustrated in FIG. 6, in the AI device calibration verification process 403, a calibration verification signal is input to the plurality of physical reservoirs included in the processing section 303.

Specifically, a signal obtained by superimposing the M-sequence noise signal on the time-series analog voltage signal is input to the plurality of physical reservoirs as the calibration verification signal. This is to take advantage of the fact that when the same random noise is input to the plurality of physical reservoirs, an event in which the outputs of the plurality of physical reservoirs become identical after a transient state (synchronization, also called consistency) occurs. In FIG. 6, reference numeral 601 is an example of the time-series analog voltage signal, and reference numeral 602 is an example of the M-sequence noise signal. Additionally, reference numeral 603 is an example of the calibration verification signal in which the M-sequence noise signal is superimposed on the time-series analog voltage signal.

As illustrated in FIG. 6, when the calibration verification signal (reference numeral 603) is input to each of the plurality of physical reservoirs included in the processing section 303, current signals are output from the plurality of physical reservoirs. The current signals output from the plurality of physical reservoirs are subjected to averaging processing at predetermined time intervals. With this, the components of the M-sequence noise signal are removed from the current signals output from the plurality of physical reservoirs, and the outputs illustrated in reference numerals 611 to 614 are obtained.

As described above, when the input of the calibration verification signal is continued, the synchronization occurs after the transient state, and the outputs illustrated in reference numerals 611 to 614 become equal to each other. With this, it is verified that the plurality of physical reservoirs included in the processing section 303 are calibrated so that the physical properties thereof are equal to each other, and the AI device calibration verification process 403 is terminated.

Here, although the example of FIG. 6 is illustrated for a single processing section 303, it is verified that the physical reservoirs are calibrated so that the physical properties of all the physical reservoirs are equal to each other by performing substantially the same processing in parallel for a plurality of processing sections other than the processing section 303.

### 2 Details of First Prediction System Generation Process

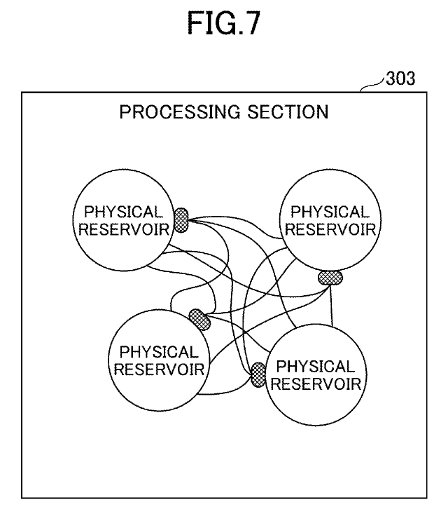

Next, details of the first prediction system generation process 404 will be described. FIG. 7 is a diagram illustrating a specific example of the first prediction system generation process. The first prediction system generation process 404 generates the processing section 303 configured to include a plurality of physical reservoirs that have been verified to be calibrated so that the physical properties are equal to each other in the AI device calibration verification process 403. Each of the physical reservoirs averages the output of the physical reservoir of the connection source in a predetermined time, applies, to the averaged output, a weight predetermined for a physical reservoir at a connection destination, and inputs it to the physical reservoir at the connection destination.

Here, although the example of FIG. 7 illustrates only one processing section 303 generated in the first prediction system generation process 404, in the first prediction system generation process 404, a plurality of processing sections each including physical reservoirs are mass-produced. The number of the physical reservoirs and the connection relationship between the physical reservoirs are equal to those in the processing section 303 illustrated in FIG. 7, and the physical reservoirs are verified to be calibrated so that physical properties are equal to each other.

Then, the AI device including the processing section 303 illustrated in FIG. 7 is mounted as the calibration-verified AI device together with the I/O control device 201, the voltage modulation device 202, and the prediction device to generate the first prediction system.

### 3 Details of Prediction Device Training Process

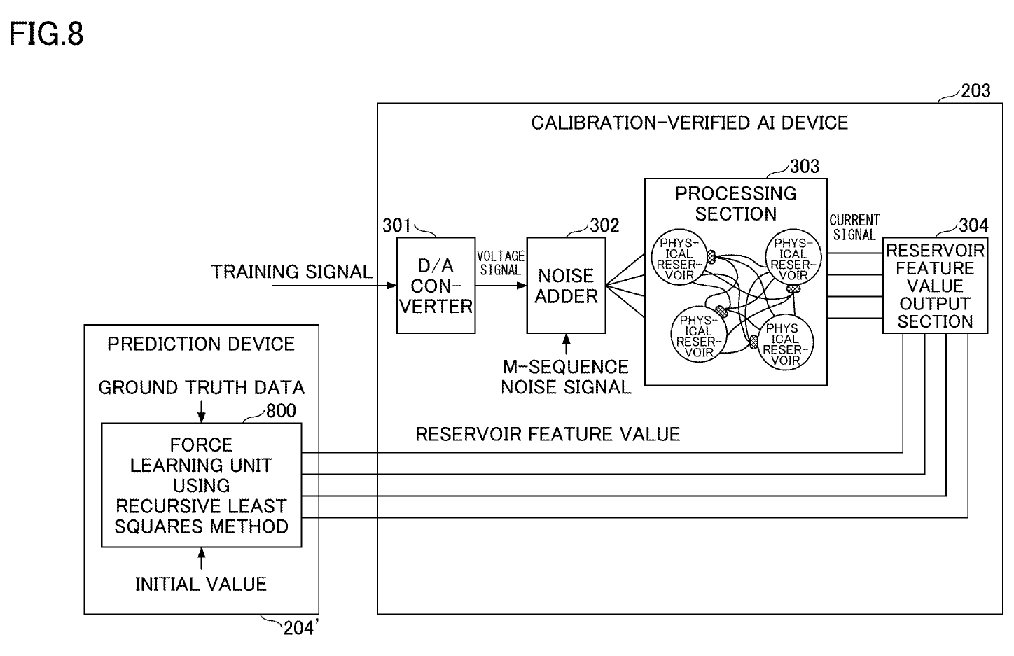

Next, details of the prediction device training process 501 will be described. FIG. 8 is a diagram illustrating a specific example of the prediction device training process in the first prediction system. As illustrated in FIG. 8, the one specific first prediction system to be trained in the prediction device training process 501 includes: the calibration-verified AI device 203; and a prediction device 204’.

Among them, the processing section 303 included in the calibration-verified AI device 203 is a processing section mass-produced in the first prediction system generation process 404. In the prediction device training process 501, first, a training signal is input to the D/A converter 301. The M-sequence noise signal is then added to the time-series analog voltage signal output from the D/A converter 301 by the noise adder 302 and the resulting signal is input to the processing section 303. With this, the current signal output from the processing section 303 is read by the reservoir feature value output section 304 and converted into voltage data, and then the converted voltage data is output as the reservoir feature value from the calibration-verified AI device 203.

The prediction device 204’ includes a FORCE learning unit 800 using the recursive least squares method before training. Initial values of the readout weights are set in the FORCE learning unit 800 using the recursive least squares method before learning. The FORCE learning unit 800 using the recursive least squares method reads the reservoir feature values with the readout weights being applied thereto, and compares them with the previously input process state data (ground truth data), thereby sequentially updating the readout weights.

With this, according to the prediction device training process 501, the readout weights are optimized in the FORCE learning unit 311 using the recursive least squares method (that is, the trained prediction device 204 is generated).

### 4 Details of Readout Weight Sharing Process

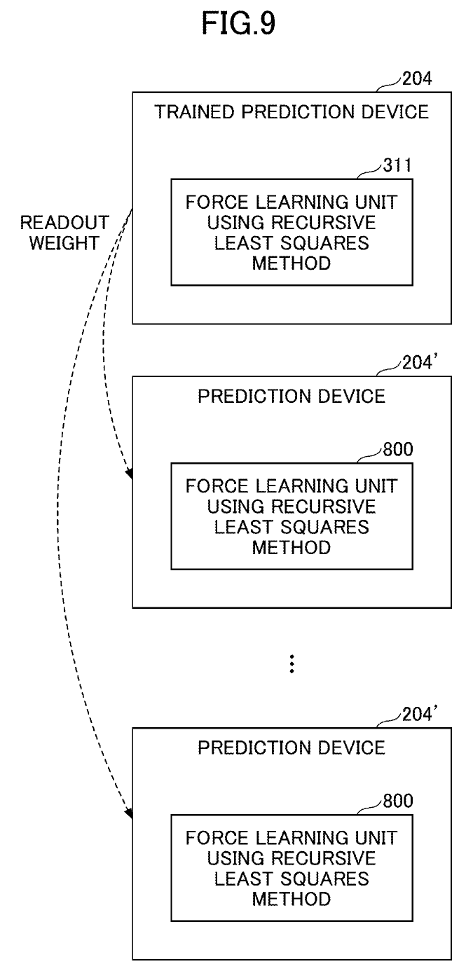

Next, details of the readout weight sharing process 502 will be described. FIG. 9 is a diagram illustrating a specific example of the readout weight sharing process for prediction devices in the first prediction system. In the example of FIG. 9, for convenience of explanation, only prediction devices among devices included in the mass-produced first prediction system are illustrated.

Among them, the trained prediction device 204 indicates a trained prediction device generated by performing training on the one specific prediction device in the prediction device training process 501. With respect to the above, the plurality of prediction devices 204’ indicate prediction devices other than the one specific prediction device, on which training has not been performed in the prediction device training process 501.

The readout weight sharing process 502 copies the readout weights of the trained prediction device 204 to the plurality of prediction devices 204’. With this, the readout weights of the trained prediction device 204 are set to the plurality of prediction devices 204’, and a plurality of trained prediction devices are generated. That is, according to the readout weight sharing process 502, the plurality of trained first prediction systems are mass-produced.

### 5 Details of Trained First Prediction System Verification Process

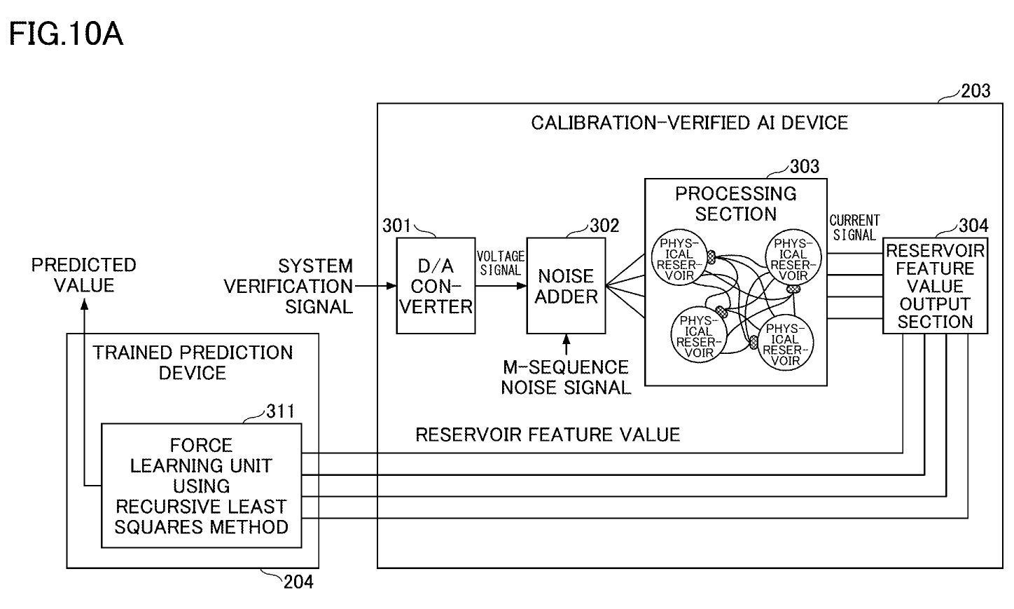

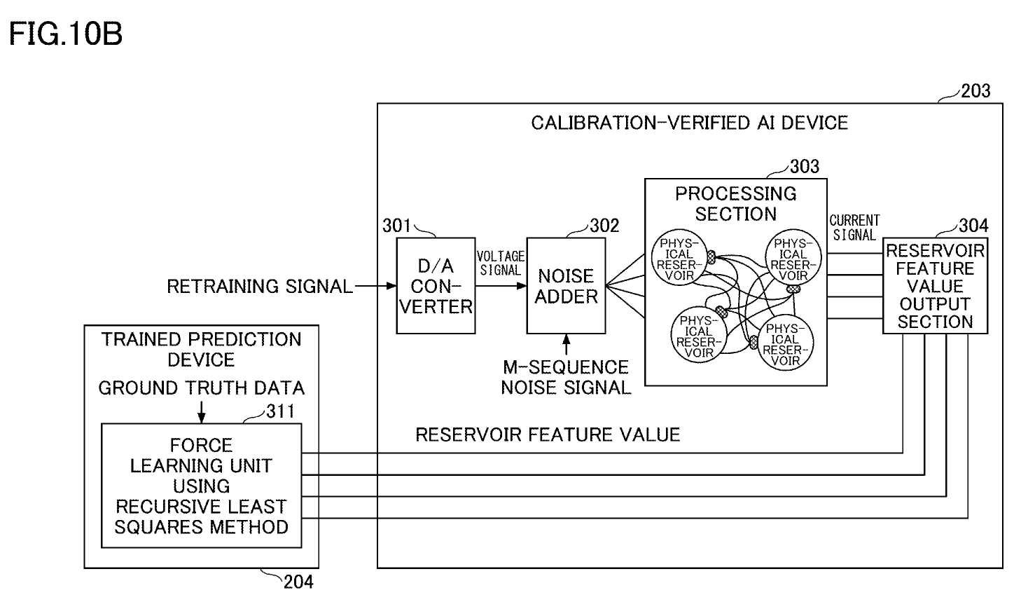

Next, details of the trained first prediction system verification process 503 will be described. FIG. 10A is a diagram illustrating a specific example of the trained first prediction system verification process. In the example of FIG. 10A, for convenience of explanation, only the calibration-verified AI device 203 and the trained prediction device 204 are illustrated among the devices included in the mass-produced trained first prediction system.

In the trained first prediction system verification process 503, first, the system verification signal is input to the D/A converter 301. The M-sequence noise signal is then added to the time-series analog voltage signal output from the D/A converter 301 by the noise adder 302. The time-series analog voltage signal to which the M-sequence noise signal is added is input to the processing section 303. With this, the current signal output from the processing section 303 is read by the reservoir feature value output section 304, is converted into voltage data, and is then output from the calibration-verified AI device 203 as the reservoir feature value.

The trained prediction device 204 outputs a predicted value by reading the reservoir feature values with the readout weights being applied thereto.

Here, although the example of FIG. 10A illustrates only one of the mass-produced trained first prediction systems for convenience of explanation, the system verification signal is input to the calibration-verified AI devices 203 of all mass-produced trained first prediction systems.

With this, predicted values are output from the trained prediction devices 204 of all mass-produced trained first prediction systems. As a result, according to the trained first prediction system verification process 503, it can be verified whether the respective predicted values are equal to each other (or within a predetermined error range).

As a result of the verification, the trained first prediction systems whose predicted values are determined to be equal to each other (or within a predetermined error range) are permitted to be mounted on the substrate processing apparatus 120.

### 6 Details of Trained Prediction Device Retraining Process

Next, details of the trained prediction device retraining process 505 will be described. FIG. 10B is a diagram illustrating a specific example of the trained prediction device retraining process in the trained first prediction system. In the example of FIG. 10B, for convenience of explanation, only the calibration-verified AI device 203 and the trained prediction device 204 are illustrated among the devices included in the trained first prediction system mounted on the substrate processing apparatus 120.

In the trained prediction device retraining process 505, first, the time-series sensor data a output from the sensor a 122a is transmitted from the I/O control device 201 to the voltage modulation device 202, and converted into voltage data in the voltage modulation device 202. Subsequently, in the trained prediction device retraining process 505, the voltage data converted in the voltage modulation device 202 is input to the D/A converter 301 as the retraining signal.

With this, the time-series analog voltage signal output from the D/A converter 301 is input to the processing section 303 after the M-sequence noise signal is added by the noise adder 302. Additionally, the current signal output from the processing section 303 is read by the reservoir feature value output section 304, converted into voltage data, and then output as the reservoir feature value. Additionally, the output reservoir feature values are input to the trained prediction device 204 including the FORCE learning unit 311 using the recursive least squares method in which the readout weights are optimized.

Subsequently, in the trained prediction device retraining process 505, the FORCE learning unit 311 using the recursive least squares method reads the reservoir feature values with the readout weights being applied thereto, and compares them with the previously input process state data (ground truth data). With this, according to the trained prediction device retraining process 505, the readout weights can be sequentially re-updated.

As a result, according to the trained prediction device retraining process 505, in the FORCE learning unit 311 using the recursive least squares method, the readout weights are retrained in accordance with the machine-to-machine difference of the substrate processing apparatuses 120 (that is, a retrained prediction device is generated).

### Summary

As is clear from the above description, the trained first prediction system 128 includes: • the processing section 303 in which the plurality of physical reservoirs configured to process the time-series analog voltage signal are connected to each other; and • the trained prediction device 204 configured to read reservoir feature values output from the plurality of physical reservoirs included in the processing section 303, with the readout weights being applied thereto, and output the predicted value.

The processing section 303 includes the plurality of physical reservoirs that have been verified to be calibrated so that the physical properties become equal to each other by adding the M-sequence noise signal to the time-series analog voltage signal. The trained prediction device 204 includes the readout weights copied from another trained prediction device. The other trained prediction device includes the plurality of other physical reservoirs that have been verified to be calibrated so that the physical properties become equal to those of the plurality of physical reservoirs by adding the common M-sequence noise signal. Additionally, the other trained prediction device is a device configured to read outputs (reservoir feature values) from the plurality of other physical reservoirs by the readout weights updated by the training processing being applied thereto and output the predicted value.

With this, according to the trained first prediction system 128, it is not necessary to perform training from scratch at startup, and the workload at startup can be reduced.

Additionally, the mass-production method according to the first embodiment includes: • performing the AI device calibration verification process 403 in which it is verified that the calibration is performed so that the physical properties of the plurality of physical reservoirs are equal to each other by inputting, to each of the plurality of physical reservoirs, the time-series analog voltage signal to which the common M-sequence noise signal is added; • performing training, in a case of generating the plurality of processing sections 303, each of which includes the plurality of verified physical reservoirs connected to each other, on the prediction device configured to read the reservoir feature values output from the plurality of physical reservoirs included in any one of the plurality of processing sections with the readout weights being applied thereto, thereby performing the prediction device training process 501 for generating one trained prediction device, and updating the readout weights of the one prediction device to generate one trained prediction device; and • performing the readout weight sharing process 502 for copying and setting the updated readout weights to the prediction devices configured to read the reservoir feature values output from the plurality of physical reservoirs in the other processing sections except the one processing section with the readout weights being applied thereto.

With this, according to the mass-production method according to the first embodiment, it is not necessary to perform training from scratch at startup, and the workload at startup can be reduced.

### Second Embodiment

The first embodiment described above is configured such that the common M-sequence noise signal is applied to the mass-produced physical reservoirs to equalize the physical properties of the physical reservoirs, thereby suppressing individual differences of the AI devices. It is configured such that when the same voltage data is input, the trained prediction device 204 can read the same reservoir feature value.

In the second embodiment, a correction device is arranged at a stage after the AI device. With this, the second embodiment is configured such that the correction device suppresses the influence of individual differences of the AI devices, and when the same voltage data is input to the AI device, the trained prediction device 204 reads the corrected reservoir feature value as the identical reservoir feature value. Hereinafter, the second embodiment will be described mainly with respect to differences from the first embodiment.

### System Configuration of Trained Second Prediction System

First, a system configuration of a trained second prediction system according to the second embodiment that is generated by performing training on a prediction system (hereinafter referred to as a second prediction system), will be described. Here, in the second embodiment, it is also assumed that the trained second prediction system is applied to the same application destination as in the first embodiment.

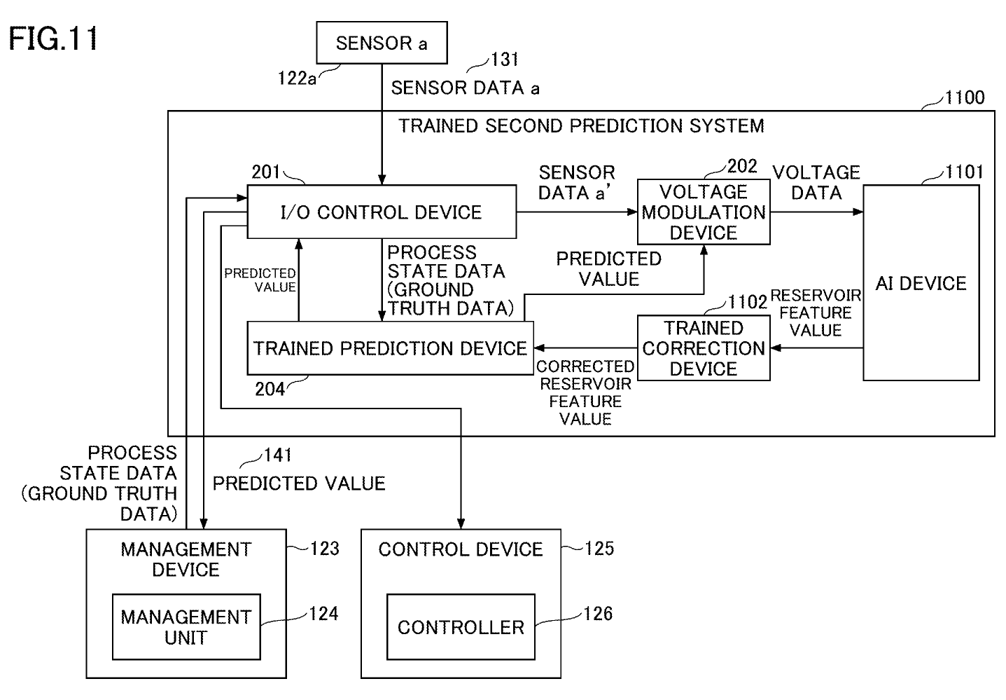

FIG. 11 is a diagram illustrating an example of the system configuration of the trained second prediction system. As illustrated in FIG. 11, a trained second prediction system 1100 has substantially the same system configuration as the trained first prediction system 128 illustrated in FIG. 2, and is different from the trained first prediction system 128 in that: • an AI device 1101 is provided instead of the calibration-verified AI device 203; • a trained correction device 1102 is provided at a stage after the AI device 1101; and • the trained prediction device 204 reads a corrected feature value (a corrected reservoir feature when the AI device 1101 includes a physical reservoir. The same applies in the description of FIG. 11) instead of the reservoir feature value.

The AI device 1101 outputs feature values (reservoir feature values when the AI device 1101 includes the physical reservoir. The same applies in the description of FIG. 11) and is one of mass-produced AI devices. However, individual differences occurring among mass-produced AI devices are not calibrated. Additionally, in the second embodiment, the AI device includes, for example, one physical reservoir, converts a current signal output from the one physical reservoir into voltage data when a voltage signal based on voltage data is input, and outputs the reservoir feature values.

The trained correction device 1102 is configured to correct the feature values output from the AI device 1101 and output the corrected feature values. As described above, mass-produced AI devices have individual differences. Therefore, even if voltage data equal to the voltage data input to the AI device 1101 is input to another mass-produced AI device, the feature value output from the AI device 1101 is different from the feature value output from the other AI device.

The trained correction device 1102 is trained so that the corrected feature value is equal to the feature value output from the other AI device.

The trained prediction device 204 is a prediction device configured to read the corrected reservoir feature values output from the trained correction device 1102 by readout weights being applied thereto and output a predicted value, and the readout weights are optimized by the training process.

### Details of Process State Prediction System

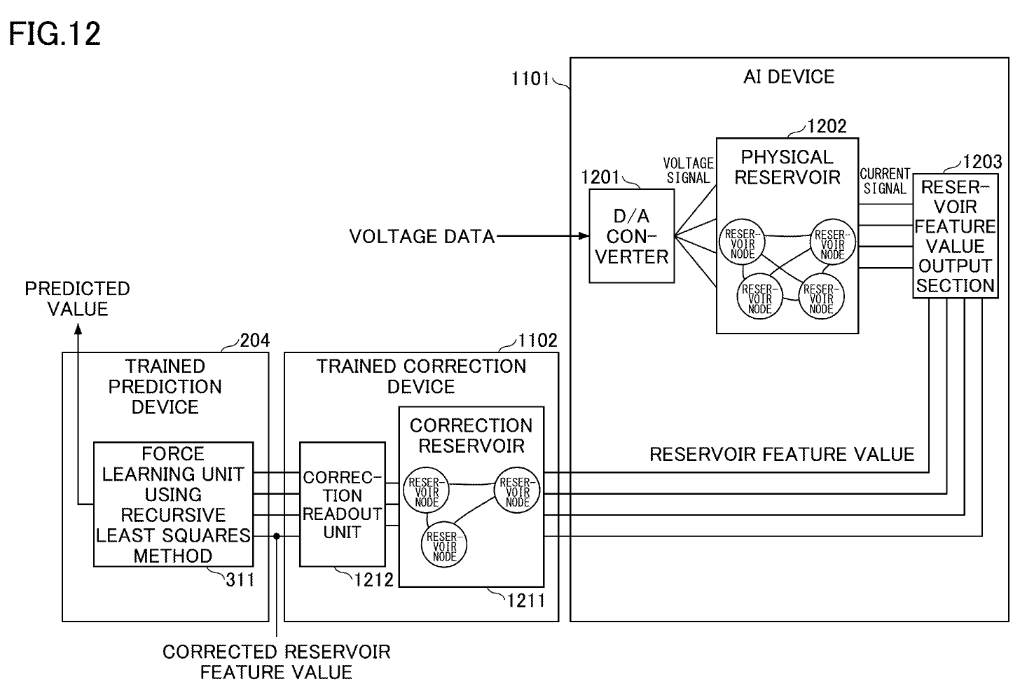

Next, a detailed configuration of the devices (here, the AI device 1101, the trained correction device 1102, and the trained prediction device 204) in the trained second prediction system 1100 illustrated in FIG. 11 will be described. FIG. 12 is a diagram illustrating an example of the detailed configuration of the AI device, the trained correction device, and the trained prediction device in the trained second prediction system. Here, for convenience of explanation, it is assumed that the AI device 1101 includes a physical reservoir.

### 1 Detailed Configuration of AI Device

First, a detailed configuration of the AI device 1101 will be described. As illustrated in FIG. 12, the AI device 1101 includes a D/A converter 1201, a physical reservoir 1202, and a reservoir feature value output section 1203.

The D/A converter 1201 performs D/A conversion on the time-series voltage data input by the voltage modulation device 202 to generate a time-series analog voltage signal, and inputs it to the physical reservoir 1202.

The physical reservoir 1202 includes a plurality of reservoir nodes configured to process the time-series analog voltage signal, and the plurality of reservoir nodes are connected to each other.

As in the first embodiment, in the second embodiment, the physical reservoir includes at least one of a nanomolecular reservoir, a spin reservoir, an optical reservoir, a CMOS reservoir, or a memristor reservoir. Additionally, as in the first embodiment, in the second embodiment, a nanomolecular reservoir is used as the physical reservoir 1202.

Here, in the AI device 1101, the physical reservoir 1202 is arranged without being calibrated.

The reservoir feature value output section 1203 reads a current signal from each of the plurality of reservoir nodes of the physical reservoir 1202, converts the current signal into a voltage signal, then converts the voltage signal into voltage data as digital data, and outputs the voltage signal as the reservoir feature value.

### 2 Detailed Configuration of Trained Correction Device

Next, a detailed configuration of the trained correction device 1102 will be described. As illustrated in FIG. 12, the trained correction device 1102 includes a correction reservoir 1211 and a correction readout unit 1212.

The correction reservoir 1211 is a replicable digital reservoir implemented by a central processing unit (CPU), a field programmable gate array (FPGA), or other circuitry. Here, the number of reservoir nodes (n) included in the correction reservoir 1211 of the trained correction device 1102, and the number of reservoir nodes (an example of a variable) (N) included in the physical reservoir 1202 of the AI device 1101 have a relationship of N > n.

The correction readout unit 1212 reads the reservoir feature value from each of the plurality of reservoir nodes of the correction reservoir 1211 and applies correction readout weights to the reservoir feature values, thereby outputting the corrected reservoir feature values.

As described above, the correction readout unit 1212 is trained so that when the same voltage data as the voltage data input to another mass-produced AI device is input to the AI device 1101, the corrected reservoir feature value output by the correction readout unit 1212 is equal to the reservoir feature value output by the other AI device (here, one specific AI device). That is, when outputting the corrected reservoir feature value, the correction readout unit 1212 applies the correction readout weight that is appropriately updated.

(3) Detailed Configuration of Trained Prediction Device

Next, a detailed configuration of the trained prediction device 204 will be described. As illustrated in FIG. 12, the trained prediction device 204 includes the FORCE learning unit 311 using the recursive least squares method.

As in the first embodiment, in the second embodiment, readout weights calculated by performing the FORCE learning process using the recursive least squares method are set to the FORCE learning unit 311 using the recursive least squares method. Alternatively, readout weights calculated by performing, by another FORCE learning unit using the recursive least squares method, the FORCE learning process using the recursive least squares method are copied and set to the FORCE learning unit 311 using the recursive least squares method. The FORCE learning unit 311 using the recursive least squares method reads the corrected reservoir feature values output from the trained correction device 1102 with the readout weights being applied thereto, and outputs a predicted value.

Here, the readout weights set in the FORCE learning unit 311 using the recursive least squares method may be re-updated by performing retraining.

### Flow from Generation to Startup of Second Prediction System

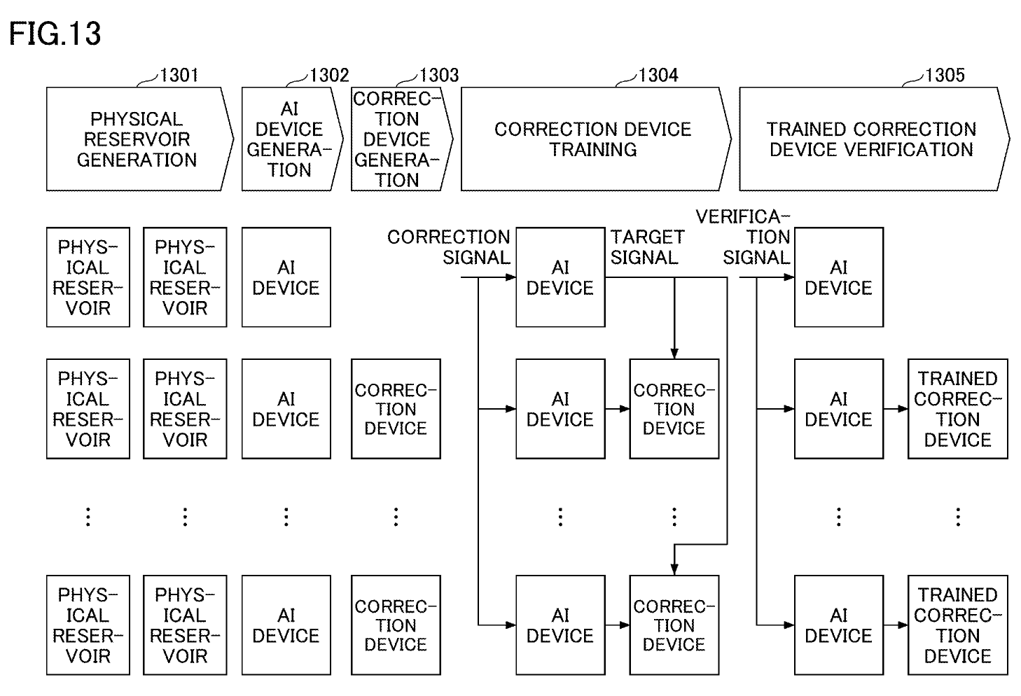

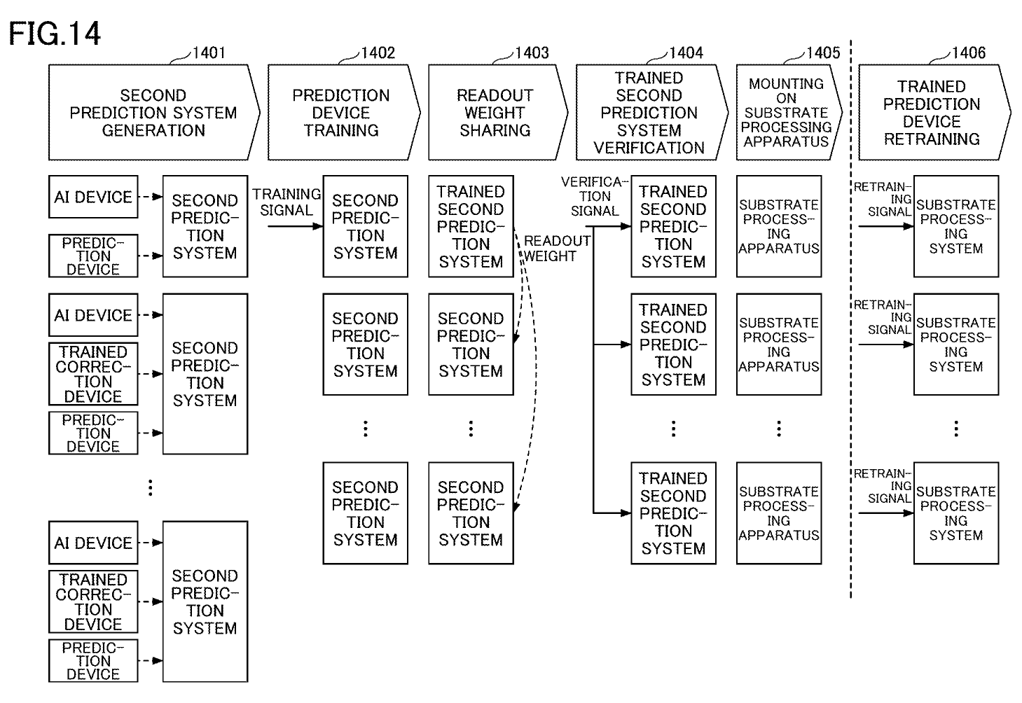

Next, a flow from generation to startup of the second prediction system will be described with reference to FIGS. 13 and 14. FIGS. 13 and 14 are first and second diagrams illustrating a flow from generation to startup of the second prediction system.

As in the first embodiment, the trained second prediction system 1100 is applied to the substrate processing apparatus 120 or the like, but generally, the substrate processing apparatus to which the trained second prediction system is applied is mass-produced and a startup process is performed at the delivery destination. Therefore, it is desirable that the trained second prediction system is also mass-produced by a method suitable for mass-production and startup.

When mass-producing the trained second prediction system, it is necessary to mass-produce physical reservoirs, but generally, when mass-producing physical reservoirs, individual differences occur among mass-produced physical reservoirs.

Therefore, when the second prediction systems are formed using the AI devices on which mass-produced physical reservoirs are mounted, individual differences also occur in the second prediction systems, and the substrate processing apparatus to which the second prediction system is applied cannot reuse the training result of another second prediction system. As a result, the substrate processing apparatus to which the second prediction system is applied needs to perform training from scratch at startup. That is, the workload at startup of the substrate processing apparatus increases.

If the influence of individual differences in AI devices on which mass-produced physical reservoirs are mounted can be suppressed and individual differences in the second prediction systems can be eliminated, there is no need to perform training from scratch at startup. This is because, for example, if training is performed by using one specific second prediction system and readout weights are calculated, a trained second prediction system can be generated for another second prediction system only by copying the calculated readout weights.

As a result, at startup of the substrate processing apparatus, instead of performing training from scratch, it is sufficient to retrain the trained second prediction system in accordance with the machine-to-machine difference of the substrate processing apparatus and to re-update the readout weights, thereby reducing the workload at startup. Hereinafter, the flow from generation to startup of the second prediction system including the mass-production method according to the second embodiment will be described with reference to FIGS. 13 and 14.

As illustrated in FIG. 13, in the second embodiment, first, a physical reservoir generation process 1301 is performed. Here, a physical reservoir (a physical reservoir including N reservoir nodes) to be mounted on the AI device is generated. As described above, the physical reservoirs mass-produced in the physical reservoir generation process 1301 have different physical properties and individual differences among the physical reservoirs mounted on the AI devices.

Subsequently, an AI device generation process 1302 is performed. As described above, the AI device includes the D/A converter 1201, the physical reservoir 1202, and the reservoir feature value output section 1203, and the physical reservoir 1202 includes N reservoir nodes. Because the physical reservoirs 1202 have individual differences, the AI devices mass-produced in the AI device generation process 1302 also have individual differences.

Subsequently, a correction device generation process 1303 is performed. The correction device generated by performing the correction device generation process 1303 includes the correction reservoir 1211 and the correction readout unit 1212, and the correction reservoir 1211 includes n reservoir nodes. The correction reservoir 1211 is a replicable digital reservoir, such as a CPU or an FPGA.

Subsequently, a correction device training process 1304 is performed. In the correction device training process 1304, when a correction signal is input to one specific AI device among a plurality of mass-produced AI devices, a reservoir feature value output from the one specific AI device is acquired as a target signal.

Additionally, in the correction device training process 1304, a correction signal identical to the correction signal input to the one specific AI device is input to an AI device other than the one specific AI device among the plurality of mass-produced AI devices.

Additionally, in the correction device training process 1304, a reservoir feature value output from the AI device other than the one specific AI device is input to a corresponding correction device. With this, a corrected reservoir feature value is output from the corresponding correction device.

Additionally, in the correction device training process 1304, the correction readout weight of the corresponding correction device is updated by performing training on the corresponding correction device so that the corrected reservoir feature value output from the corresponding correction device is equal to the acquired target signal. With this, according to the correction device training process 1304, a trained correction device including an appropriate correction readout weight can be generated.

Subsequently, a trained correction device verification process 1305 is performed. The trained correction device verification process 1305 inputs an identical verification signal to the plurality of mass-produced AI devices. With this, it can be verified that each of the plurality of trained correction devices outputs a corrected reservoir feature value that is equal to (or within a predetermined error range of) the output (reservoir feature value) of the one specific AI device.

Subsequently, as illustrated in FIG. 14, a second prediction system generation process 1401 is performed. The second prediction system generated by performing the second prediction system generation process 1401 includes the I/O control device 201, the voltage modulation device 202, the AI device 1101, the trained correction device 1102, and the prediction device. However, the trained correction device 1102 is not included in the second prediction system in which the one specific AI device selected in the correction device training process 1304 is mounted. Here, the prediction device is a device including the FORCE learning unit using the recursive least squares method before training for the readout weight.

With this, according to the second prediction system generation process 1401, the second prediction systems in which the individual differences of the AI devices are suppressed can be mass-produced.

Subsequently, a prediction device training process 1402 is performed. The prediction device training process 1402 inputs a training signal to the one specific second prediction system among the plurality of mass-produced second prediction systems to perform training on the one specific second prediction system. With this, the readout weights of the one specific second prediction system are optimized, and the trained second prediction system is generated.

Subsequently, a readout weight sharing process 1403 is performed. The readout weight sharing process 1403 copies the readout weights of the trained second prediction system to a plurality of second prediction systems other than the one specific second prediction system. With this, according to the readout weight sharing process 1403, the trained second prediction systems can be mass-produced for the plurality of second prediction systems other than the one specific second prediction system.

Subsequently, a trained second prediction system verification process 1404 is performed. The trained second prediction system verification process 1404 inputs an identical verification signal to the plurality of mass-produced trained second prediction systems. With this, it can be verified that the trained second prediction system verification process 1404 outputs the identical (or within a predetermined error range) predicted value.

Subsequently, a mounting process 1405 on the substrate processing apparatus is performed. The mounting process on the substrate processing apparatus 1405 mounts, on the mass-produced substrate processing apparatuses, a plurality of trained second prediction systems that are verified to have output the identical (or within a predetermined error range) predicted value as a result of verification by the trained second prediction system verification process 1404. Here, the substrate processing apparatuses in which the trained second prediction systems are mounted are delivered to respective delivery destinations, and installation work is performed.

When the installation work is completed, the startup process is performed for the substrate processing apparatus. At this time, because the prediction system mounted on the substrate processing apparatus has already been trained, a trained prediction device retraining process 1406 for performing retraining in accordance with the machine-to-machine difference between the substrate processing apparatuses is performed in the startup process.

Specifically, the trained prediction device retraining process 1406 performs retraining by inputting the retraining signal to the trained second prediction system mounted on the substrate processing apparatus, and re-updates the readout weights.

As described, according to the flow from generation to startup of the second prediction system including the mass-production method according to the second embodiment, the workload at startup can be reduced.

### Details of Each Process

Next, details of each of the processes from generation to startup of the second prediction system will be described. Here, details of the correction device training process 1304, the trained correction device verification process 1305, the prediction device training process 1402 to the trained second prediction system verification process 1404, and the trained prediction device retraining process 1406 will be described.

### 1 Details of Correction Device Training Process

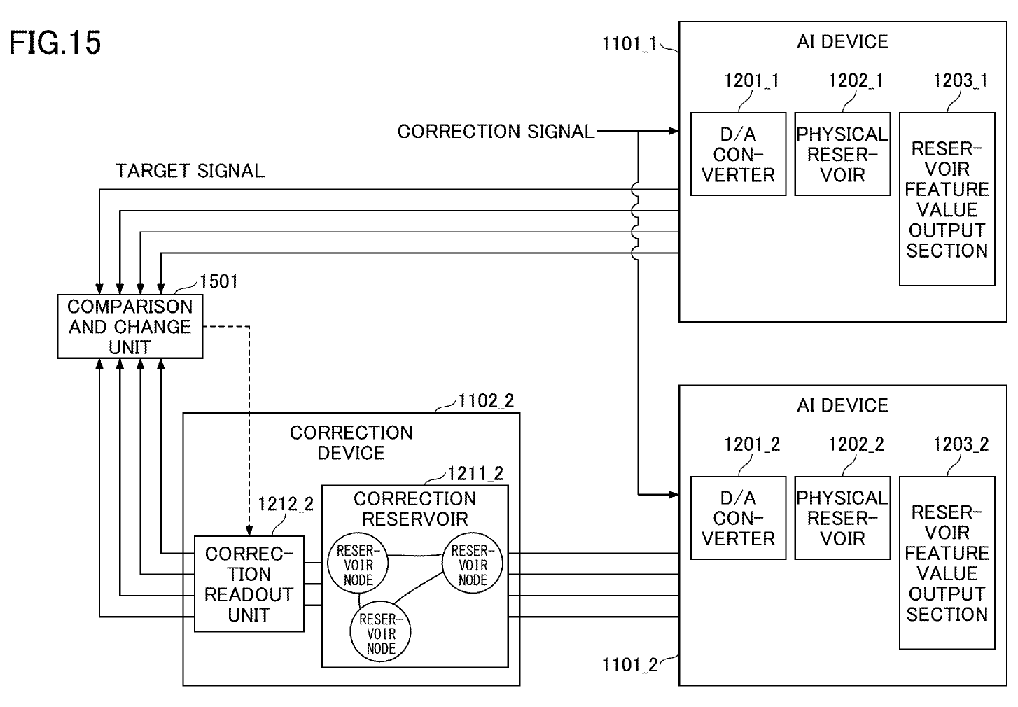

First, details of the correction device training process 1304 will be described. FIG. 15 is a diagram illustrating a specific example of the correction device training process. As illustrated in FIG. 15, in the correction device training process 1304, first, a correction signal is input to one specific AI device 1101_1 among the plurality of mass-produced AI devices. With this, a reservoir feature value is output from the one specific AI device 1101_1. Here, in the correction device training process 1304, the reservoir feature value output from the one specific AI device 1101_1 is used as a target signal.

In FIG. 15, an AI device 1101_2 is one of the AI devices other than the one specific AI device 1101_1 among the plurality of mass-produced AI devices. In the correction device training process 1304, a correction signal identical to the correction signal input to the one specific AI device 1101_1 is input to the AI device 1101_2. With this, a reservoir feature value is output from the AI device 1101_2.

Subsequently, in the correction device training process 1304, the reservoir feature value output from the AI device 1101_2 is input to a correction reservoir 1211_2 of a correction device 1102_2.

Subsequently, in the correction device training process 1304, a correction readout unit 1212_2 of the correction device 1102_2 reads the reservoir feature values with correction readout weights being applied thereto, thereby outputting the corrected reservoir feature values. With this, the corrected reservoir feature values output from the correction readout unit 1212_2 are compared with the target signal in a comparison change unit 1501, and the correction readout weights of the correction readout unit 1212_2 are updated in accordance with the comparison result.

As described, according to the correction device training process 1304, training is performed on the correction readout unit 1212_2, thereby generating the trained correction device in which the correction readout weights of the correction readout unit 1212_2 are optimized.

Here, in the example of FIG. 15, the case where training is performed on the correction device 1102_2 corresponding to the AI device 1101_2 has been described. However, the device to be trained in the correction device training process 1304 is not limited to the correction device 1102_2 corresponding to the AI device 1101_2. It is assumed that substantially the same training is performed in parallel on all correction devices corresponding to all AI devices other than the one specific AI device 1101_1 among the mass-produced AI devices.

### (2) Trained Correction Device Verification Process

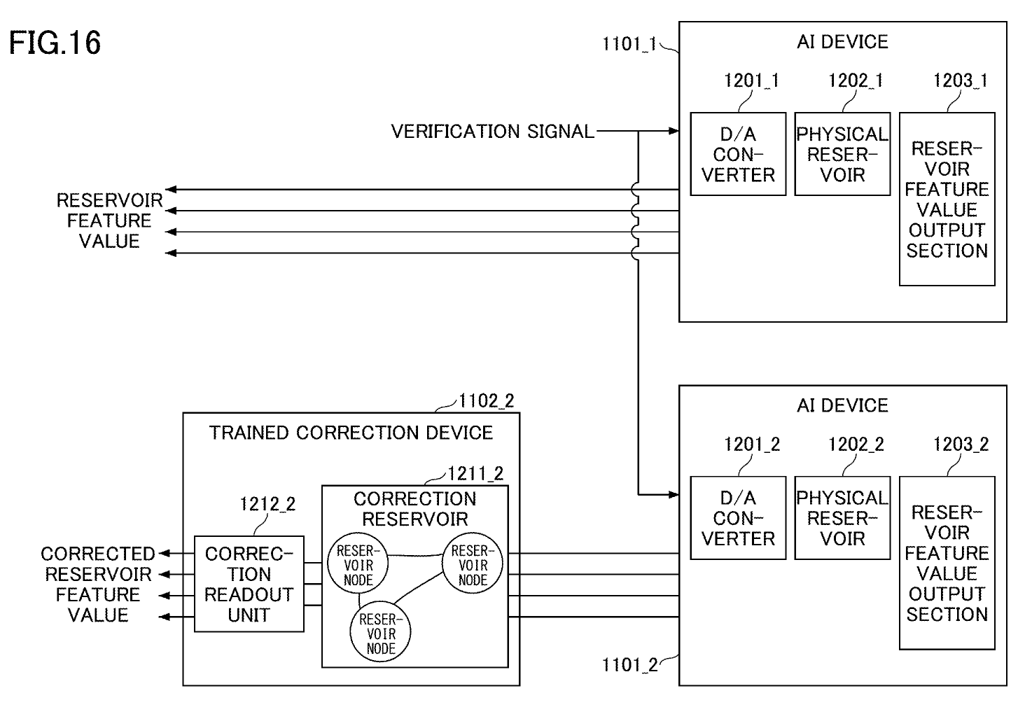

Next, details of the trained correction device verification process 1305 will be described. FIG. 16 is a diagram illustrating a specific example of the trained correction device verification process. In the example of FIG. 16, for convenience of explanation, only the one specific AI device 1101_1, the AI device 1101_2 other than the one specific AI device, and the trained correction device 1102_2 corresponding to the AI device 1101_2 are illustrated among the mass-produced AI devices.

In the trained correction device verification process 1305, first, a verification signal is input to the AI device 1101_1. With this, the reservoir feature values are output from the AI device 1101_1.

Subsequently, in the trained correction device verification process 1305, a verification signal identical to the verification signal input to the one specific AI device 1101_1 is input to the AI device 1101_2.

With this, the reservoir feature values are output from the AI device 1101_2. In the trained correction device verification process 1305, the reservoir feature values output from the AI device 1101_2 are input to the correction reservoir 1211_2 of the corresponding trained correction device 1102_2.

Subsequently, in the trained correction device verification process 1305, the correction readout unit 1212_2 reads the output of the correction reservoir 1211_2 with the correction readout weights being applied thereto, thereby outputting the corrected reservoir feature values.

With this, according to the trained correction device verification process 1305, it can be verified whether the reservoir feature value output from the one specific AI device 1101_1 is equal to (or within a predetermined error range of) the corrected reservoir feature value output from the trained correction device 1102_2.

### 3 Details of Prediction Device Training Process

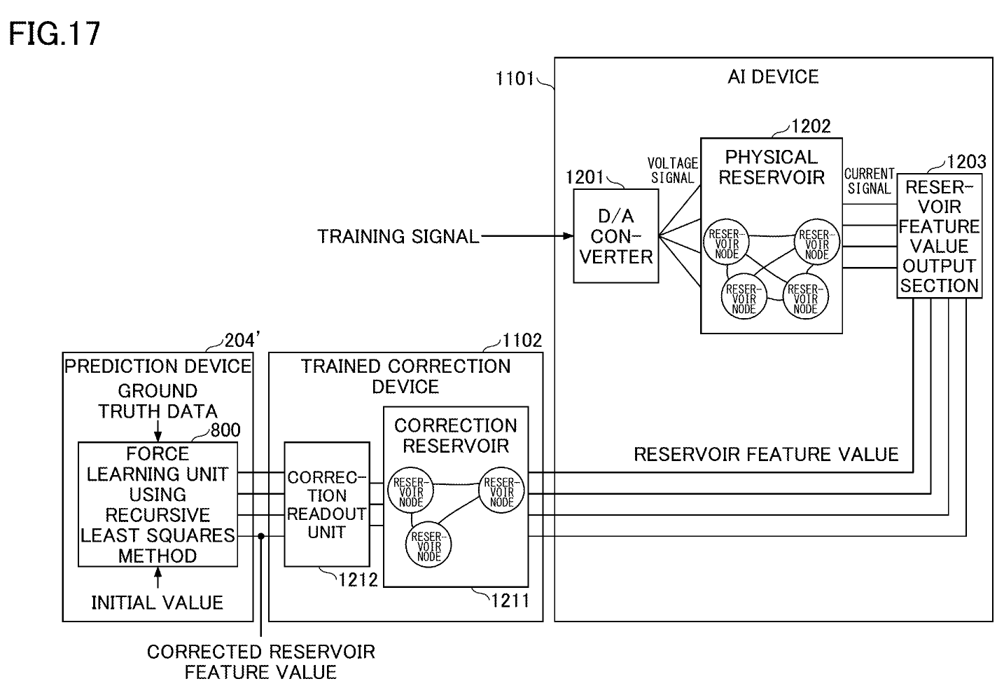

Next, details of the prediction device training process 1402 will be described. FIG. 17 is a diagram illustrating a specific example of the prediction device training process in the second prediction system. As illustrated in FIG. 17, one specific second prediction system on which training is performed in the prediction device training process 1402 includes: • the AI device 1101; • the trained correction device 1102; and • the prediction device 204’.

The correction readout unit 1212 included in the trained correction device 1102 includes the correction readout weights optimized in the correction device training process 1304 and verified in the trained correction device verification process 1305.

The prediction device training process 1402 first inputs a training signal to the AI device 1101_1. With this, the reservoir feature values are output from the AI device 1101.

Subsequently, the prediction device training process 1402 inputs the reservoir feature values output from the AI device 1101 to the correction reservoir 1211 of the trained correction device 1102.

Subsequently, the prediction device training process 1402 outputs the corrected reservoir feature values by reading the output of the correction reservoir 1211 with the correction readout weights being applied thereto by the correction readout unit 1212.

The prediction device 204’ includes the FORCE learning unit 800 using the recursive least squares method before the training. The initial values of the readout weights are set in the FORCE learning unit 800 using the recursive least squares method before the training is performed.

Subsequently, in the prediction device training process 1402, the FORCE learning unit 800 using the recursive least squares method reads the corrected reservoir feature values with the readout weights being applied thereto, and compares them with the ground truth data input in advance, thereby sequentially updating the readout weights.

As described, according to the prediction device training process 1402, the FORCE learning unit 311 using the recursive least squares method (that is, the trained prediction device 204) in which the readout weights are optimized can be generated.

### (3) Details of Readout Weight Sharing Process

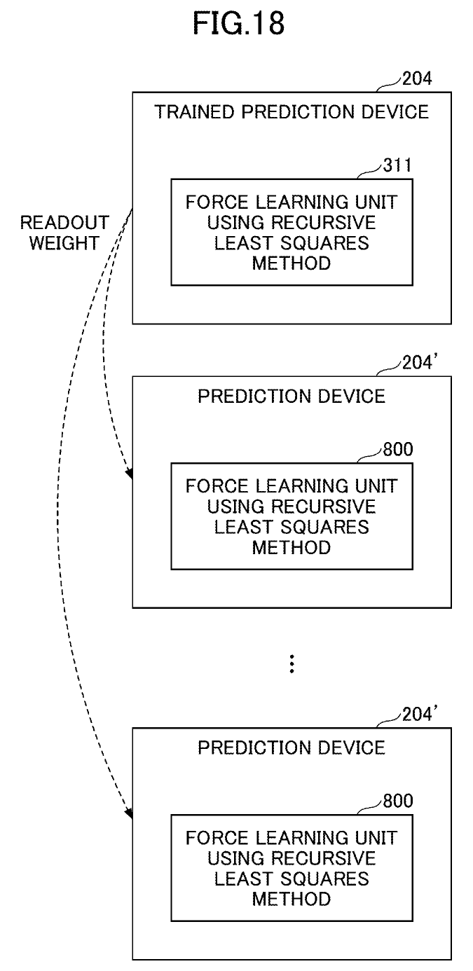

Next, details of the readout weight sharing process 1403 will be described. FIG. 18 is a diagram illustrating a specific example of the readout weight sharing process of the prediction devices in the second prediction system. In the example of FIG. 18, for convenience of explanation, only the prediction devices are illustrated among the devices included in the mass-produced second prediction system.

Among the devices, the trained prediction device 204 indicates a trained prediction device (source prediction device) generated by performing training on one specific prediction device in the prediction device training process 1402. The plurality of prediction devices 204’ indicate prediction devices other than the one specific prediction device, on which training has not been performed in the prediction device training process 1402.

In the readout weight sharing process 1403, the readout weights of the trained prediction device 204 are copied to the plurality of prediction devices 204’. With this, the readout weights of the trained prediction device 204 are set to the plurality of prediction devices 204’, and the plurality of trained prediction devices are generated. That is, according to the readout weight sharing process 1403, the plurality of trained second prediction systems are mass-produced.

### 4 Details of Trained Second Prediction System Verification Process

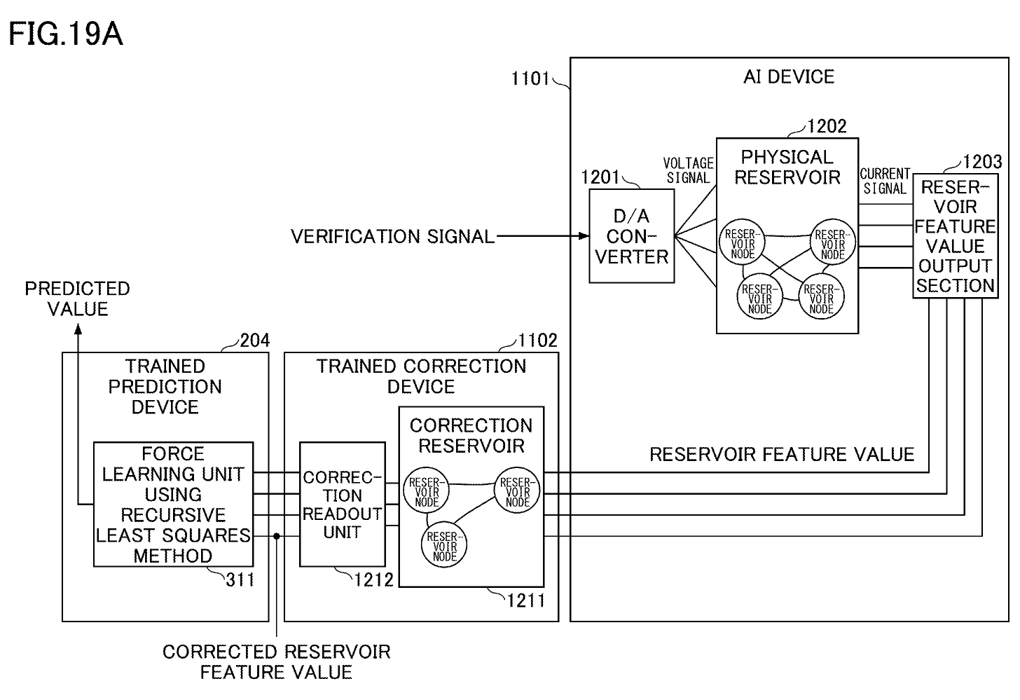

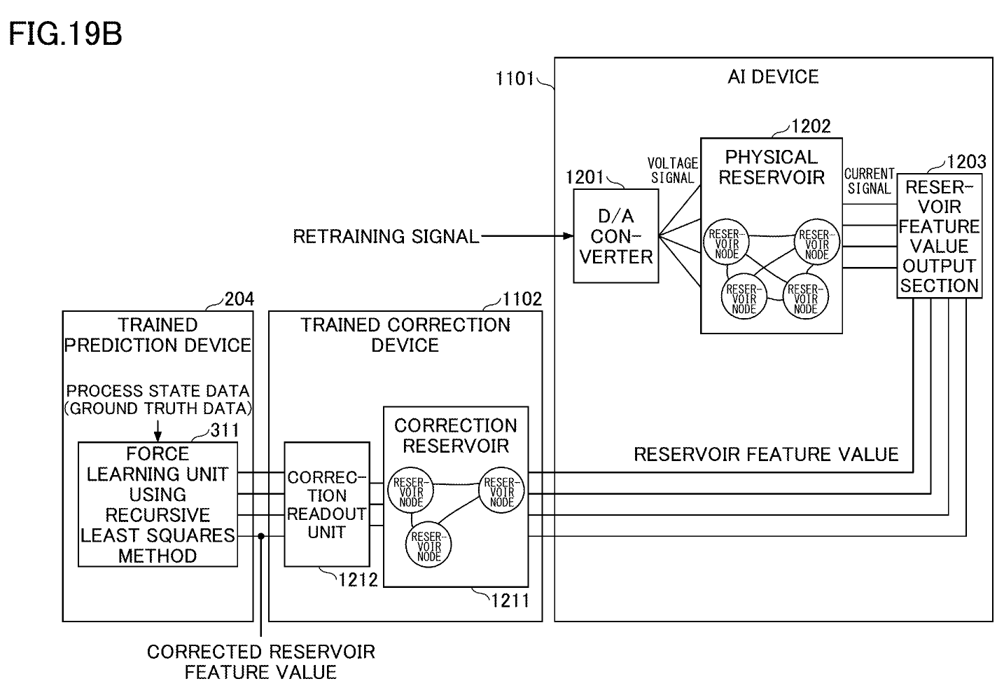

Next, details of the trained second prediction system verification process 1404 will be described. FIG. 19A is a diagram illustrating a specific example of the trained second prediction system verification process. In the example of FIG. 19A, for convenience of explanation, only the AI device 1101, the trained correction device 1102, and the trained prediction device 204 are illustrated among the devices included in the mass-produced trained second prediction system.

In the trained second prediction system verification process 1404, first, a verification signal is input to the AI device 1101. With this, the reservoir feature values are output from the AI device 1101.

Subsequently, in the trained second prediction system verification process 1404, the reservoir feature values output from the AI device 1101 are input to the correction reservoir 1211 of the trained correction device 1102.

Subsequently, in the trained second prediction system verification process 1404, the correction readout unit 1212 reads the output of the correction reservoir 1211 with the correction readout weights being applied thereto, thereby outputting the corrected reservoir feature values.

Subsequently, in the trained second prediction system verification process 1404, the trained prediction device 204 reads the corrected reservoir feature values with the readout weights being applied thereto, thereby outputting the predicted value.

Here, although, in the example of FIG. 19A, for convenience of explanation, only one trained second prediction system among the mass-produced trained second prediction systems is illustrated, the verification signal is input to the AI devices 1101 of all mass-produced trained second prediction systems.

With this, the predicted values are output from the trained prediction devices 204 of all mass-produced trained second prediction systems. As a result, according to the trained second prediction system verification process 1404, it can be verified whether the respective predicted values are equal to (or within a predetermined error range of) each other.

Here, as a result of the verification, the trained second prediction systems whose predicted values are determined to be equal (or within a predetermined error range) are permitted to be mounted on the substrate processing apparatus 120.

### 5 Details of Trained Prediction Device Retraining Process

Next, details of the trained prediction device retraining process 1406 will be described. FIG. 19B is a diagram illustrating a specific example of the trained prediction device retraining process in the trained second prediction system. In the example of FIG. 19B, for convenience of explanation, only the AI device 1101, the trained correction device 1102, and the trained prediction device 204 are illustrated among the devices included in the trained second prediction system mounted on the substrate processing apparatus 120.

In the trained prediction device retraining process 1406, first, the time-series sensor data a output from the sensor a 122a is transmitted from the I/O control device 201 to the voltage modulation device 202, and converted into voltage data in the voltage modulation device 202. Subsequently, in the trained prediction device retraining process 1406, the voltage data converted by the voltage modulation device 202 is input to the AI device 1101 as the retraining signal. With this, the reservoir feature values are output from the AI device 1101.

Subsequently, in the trained prediction device retraining process 1406, the reservoir feature values output from the AI device 1101 are input to the correction reservoir 1211 of the trained correction device 1102.

Subsequently, in the trained prediction device retraining process 1406, the correction readout unit 1212 reads the output of the correction reservoir 1211 with the correction readout weights being applied thereto, thereby outputting the corrected reservoir feature values. Additionally, the output reservoir feature values are input to the trained prediction device 204 including the FORCE learning unit 311 using the recursive least squares method in which the readout weights are optimized.

Subsequently, in the trained prediction device retraining process 1406, the FORCE learning unit 311 using the recursive least squares method reads the reservoir feature values with the readout weights being applied thereto, and compares them with the previously input process state data (ground truth data). With this, according to the trained prediction device retraining process 1406, the readout weights can be sequentially re-updated.

As a result, according to the trained prediction device retraining process 1406, the FORCE learning unit 311(that is, a retrained prediction device) using the recursive least squares method in which retraining is performed in accordance with the machine-to-machine difference of the substrate processing apparatus 120 can be generated.

### Summary

As is clear from the above description, the trained second prediction system 1100 includes: • the AI device 1101 configured to process the time-series signal and the trained correction device 1102 configured to correct the reservoir feature values output from the AI device 1101; and • the trained prediction device configured to read the reservoir feature values corrected by the trained correction device 1102 with the readout weights being applied thereto and output the predicted value.

Additionally, in the trained second prediction system 1100, • the trained correction device 1102 includes the correction reservoir 1211 and the correction readout unit 1212 configured to read the output of the correction reservoir 1211 with the correction readout weights being applied thereto, • the correction readout unit 1212 reads the output from the correction reservoir 1211 when the reservoir feature values output from the AI device 1101 when the time series signal is processed are input to the correction reservoir 1211, with the correction readout weights being applied thereto, and then the correction readout unit 1212 outputs the corrected reservoir feature values, • the correction readout unit 1212 includes the correction readout weights updated by the training process based on the error between the corrected reservoir feature values and the reservoir feature values output from the other AI device when the other AI device processes the correction signal, and • the trained prediction device includes the readout weights copied from the trained other prediction device when the trained other prediction device whose readout weights have been re-updated by performing the training process on the other prediction device is a source prediction device.

With this, according to the trained second prediction system 1100, it is not necessary to perform training from scratch at startup, and the workload at startup can be reduced.

Additionally, the mass-production method according to the second embodiment includes: • mass-producing, when the plurality of AI devices configured to process the time-series signal are generated, correction devices configured to correct the reservoir feature values output from the AI devices except the one specific AI device so as to match with the reservoir feature values output from the one specific AI device; • mass-producing the prediction devices each configured to output the predicted value by reading the reservoir feature values corrected by the correction device with the readout weights copied from the source prediction device being applied thereto; • acquiring, when mass-producing the correction devices, the reservoir feature values output from the one specific AI device when the correction signal is input as the target signal; • inputting, when mass-producing the correction devices, the reservoir feature values output from the other AI devices except the one specific AI device when the correction signal is input to the other AI devices except the one specific AI device to the corresponding correction devices, and then outputting, by the corresponding correction devices, the corrected reservoir feature values; • updating, when mass-producing the correction devices, the correction readout weights by performing the training process on the correction device based on the errors between the target signal and the corrected reservoir feature values; and • updating, when mass-producing the prediction devices, the readout weights by reading the output of the one specific AI device with the readout weights being applied thereto, performing the training process on the one specific prediction device having output the predicted value. The updated readout weights are copied from the one specific prediction device to each of the other prediction devices except the one specific AI device.

With this, according to the mass-production method according to the second embodiment, it is not necessary to perform training from scratch at startup, and the workload at startup can be reduced.

### Other Embodiments

In the second embodiment, the description assumes that the AI device 1101 is a device including the physical reservoir. However, the target device whose output is corrected by the trained correction device 1102 is not limited to the device including the physical reservoir. A device that cannot be corrected by the linear optimization method in a high-order nonlinear system may be used as the target device.

Additionally, in the second embodiment, the description assumes that the number N of reservoir nodes of the physical reservoir of the AI device 1101 and the number n of reservoir nodes of the correction reservoir of the trained correction device 1102 have the relationship N>n. However, the relationship between the number N of reservoir nodes of the physical reservoir of the AI device 1101 and the number n of reservoir nodes of the correction reservoir of the trained correction device 1102 may be set to the optimum ratio based on the prediction accuracy or storage capacity.

Additionally, in the first and second embodiments described above, the case of outputting the presence or absence of an abnormality or sensor data as the predicted value obtained by predicting the process state has been described. However, the predicted value output by the trained prediction device 204 is not limited to the presence or absence of an abnormality or sensor data, but may be, for example, a level indicating the process state or the presence or absence of a failure in an apparatus for performing a manufacturing process.

Here, the present invention is not limited to the configuration described in the above embodiments, such as a combination with other elements. These points can be changed within a range not departing from the spirit of the present invention, and can be appropriately defined according to the application mode.

A workload at startup in a prediction system including an AI device can be reduced.

What is claimed is:

1. A prediction system comprising:
a calibration-verified AI device in which a plurality of physical reservoirs configured to process a time-series signal are connected to each other; and
a trained prediction device configured to read outputs from the plurality of physical reservoirs included in the calibration-verified AI device with readout weights being applied thereto and output a predicted value,
wherein the calibration-verified AI device includes the plurality of physical reservoirs verified to be calibrated so that physical properties of the plurality of physical reservoirs become equal to each other by adding an M-sequence noise to the time-series signal, and
wherein the trained prediction device includes the readout weights that are copied from another trained prediction device in which readout weights have been updated by performing training, the another trained prediction device being configured to read outputs from a plurality of other physical reservoirs having physical properties equal to the physical properties of the plurality of physical reservoirs with the readout weights being applied thereto and output a predicted value.

2. The prediction system as claimed in claim 1, wherein the plurality of physical reservoirs connected to each other are configured such that an output of a physical reservoir at a connection source is averaged over a predetermined time, a weight between the physical reservoir at the connection source and a physical reservoir at a connection destination is applied, and then the output is input to the physical reservoir at the connection destination.

3. The prediction system as claimed in claim 1, wherein the plurality of physical reservoirs included in the calibration-verified AI device and the plurality of other physical reservoirs are equal to each other in number and connection relationship.

4. The prediction system as claimed in claim 1, wherein the readout weights of the trained prediction device are re-updated by performing retraining using a time-series signal acquired in an apparatus on which the prediction system is mounted.

5. A mass production method comprising:
verifying that calibration is performed so that physical properties of a plurality of physical reservoirs become equal to each other by inputting, to each of the plurality of physical reservoirs, a time-series signal to which a common M-sequence noise is added;
updating, in a case of generating a plurality of calibration-verified AI devices by generating a plurality of processing sections, each of which connects the plurality of verified physical reservoirs to each other, readout weights by performing training on a prediction device configured to read outputs from one specific calibration-verified AI device with readout weights being applied thereto; and
copying and setting the updated readout weights to prediction devices configured to read outputs from calibration-verified AI devices other than the one specific calibration-verified AI device with readout weights being applied thereto.

6. The mass production method as claimed in claim 5, wherein the updating of the readout weights includes, in the plurality of physical reservoirs connected to each other included in the one specific calibration-verified AI device, averaging an output of a physical reservoir at a connection source over a predetermined time, applying a weight between the physical reservoir at the connection source and a physical reservoir at a connection destination, and then inputting the output to the physical reservoir at the connection destination.

7. The mass production method as claimed in claim 5, wherein the updating of the readout weights includes calculating an error by comparing a predicted value output from the prediction device by reading the outputs from the plurality of physical reservoirs included in the one specific calibration-verified AI device with the readout weights being applied, with ground truth data, and updating the readout weights based on the calculated error.

8. The mass production method as claimed in claim 7, wherein the updating of the readout weights includes updating the readout weights by performing FORCE learning based on the calculated error.

9. The mass production method as claimed in claim 5, wherein the plurality of physical reservoirs included in each of the plurality of calibration-verified AI devices are equal to each other in number and connection relationship among the plurality of calibration-verified AI devices.

10. The mass production method as claimed in claim 5, further comprising verifying that predicted values respectively output from the plurality of prediction devices are equal to each other, the predicted values being output by reading outputs of the plurality of calibration-verified AI devices with the updated readout weights being applied thereto, in response to a time-series signal to which a common M-sequence noise is added being input to the plurality of calibration-verified AI devices.

11. A prediction system comprising:
a target device configured to process a time-series signal and output feature values;
a correction device configured to correct the feature values output by the target device; and
a prediction device configured to read the feature values corrected by the correction device with readout weights of a source prediction device being applied thereto, and output a predicted value,
wherein the correction device is configured to:
receive and process the feature values output by the target device; and
correct the feature values by reading the processed feature values with correction readout weights being applied, and
wherein the correction readout weights are updated by performing training based on errors between feature values output by another target device by a training signal being processed by the another target device and the feature values output by the target device by the training signal being processed by the target device and corrected by the correction device.

12. The prediction system as claimed in claim 11, wherein the prediction device includes the readout weights that are copied from the source prediction device configured to read the outputs of the another target device with readout weights being applied thereto and output a predicted value and the readout weights have been updated by performing learning.

13. The prediction system as claimed in claim 12, wherein the target device is an AI device including N variables, and the correction device includes a digital reservoir including n nodes (N > n).

14. The prediction system as claimed in claim 13, wherein the correction device reads the processed feature values with the correction readout weight being applied thereto, and outputs N corrected feature values.

15. The prediction system as claimed in claim 14, wherein the readout weight of the source prediction device in the prediction device is re-updated by performing retraining using a time-series signal acquired in an apparatus on which the prediction system is mounted.

16. A mass production method for mass-producing a correction device configured to perform correction, in a case where a plurality of target devices configured to process a time-series signal are generated, to match feature values respectively output by target devices other than one specific target device among the plurality of target devices with feature values output by the one specific target device, and a prediction device configured to output a predicted value by reading the corrected feature values with readout weights of a source prediction device being applied thereto, the mass production method comprising:
acquiring, as a target signal, feature values output by the one specific target device in response to a time-series signal being input thereto;
acquiring, by inputting the feature values output by the target devices other than the one specific target device in response to the time-series signal being input to the target devices other than the one specific target device to correction reservoirs included in corresponding correction devices, corrected feature values by reading outputs from the correction reservoirs with correction readout weights being applied thereto; and
updating the correction readout weights by performing training based on errors between the target signal and the corrected feature values.

17. The mass production method as claimed in claim 16, further comprising copying the readout weights from the source prediction device to the prediction devices other than the source prediction device, the source prediction device being configured to read the feature values output by the one specific target device with the readout weights being applied thereto and output a predicted value, and the readout weight of the source prediction device being updated by performing training.

18. The mass production method as claimed in claim 17, wherein the target device is an AI device including N variables, and the correction reservoir is a digital reservoir having n nodes (N > n).

19. The mass production method as claimed in claim 18, wherein the outputs of the correction reservoirs are read with the correction readout weights being applied thereto and N corrected feature values are acquired.

20. The mass production method as claimed in claim 16, further comprising verifying that a predicted value output from the source prediction device and a predicted value output from each of the prediction devices other than the source prediction device to which the copied readout weights are set are equal to each other, in response to identical time-series signals being input to the plurality of target devices.
